(19) United States
(12) Patent Application Publication
(10) Pub. No.: US 2023/0309180 A1
(43) Pub. Date: Sep. 28, 2023

(54) SURVIVAL TIME IN RADIO ACCESS NETWORK

(71) Applicant: Samsung Electronics Co., Ltd., Suwon-si, Gyeonggi-do (KR)

(72) Inventors: Milos TESANOVIC, Staines (GB); Sangkyu BAEK, Suwon-si (KR)

(21) Appl. No.: 18/040,793

(22) PCT Filed: Aug. 4, 2021
(86) PCT No.: PCT/KR2021/010274

§ 371 Date: Feb. 6, 2023

(30) Foreign Application Priority Data
Aug. 5, 2020 (GB) 2012196.8
Mar. 26, 2021 (GB) 2104327.8

(51) Int. Cl. H04W 76/25

(52) U.S. Cl. CPC H04W 76/25

(57) ABSTRACT

A method of a terminal for performing uplink communications with an access point in a mobile communications system, the method comprising: transmitting uplink data of an application to the access point based on a first set of uplink transmission parameters; detecting a trigger condition for entry into a survival time state for the application, and if the trigger condition is detected, entering into a survival time state for the application, and when in the survival time state for the application, transmitting uplink data of the application to the access point based on a second set of uplink transmission parameters.

### CROSS-REFERENCE TO RELATED APPLICATIONS

This application is a 371 National Stage of International Application No. PCT/KR2021/010274, filed Aug. 4, 2021, which claims priority to United Kingdom Patent Application No. 2012196.8, filed Aug. 5, 2020, and United Kingdom Patent Application No. 2104327.8, filed Mar. 26, 2021, the disclosures of which are herein incorporated by reference in their entirety.

### BACKGROUND

### 1. Field

The present disclosure relates to the implementation of a survival time in a Radio Access network (RAN).

### 2. Description of Related Art

Wireless or mobile (cellular) communications networks in which a terminal (such as a mobile handset) communicates via a radio link with a network of base stations, or other wireless access points or nodes, have undergone rapid development through a number of generations. The 3rd Generation Partnership Project (3GPP) design, specify and standardise technologies for mobile wireless communication networks. Fifth Generation (5G) systems are now being deployed.

As part of 5G network technologies, a new air interface has been developed, which may be referred to as 5G New Radio (5G NR) or simply NR. NR is designed to support the wide variety of services and use case scenarios envisaged for 5G networks, though builds upon established LTE technologies. One aspect of NR is its increased provisions for Internet of Things (IoT)/Machine-Type Communications (MTC) applications, and in particular, Industrial Internet of Things (IIoT). Although NR Release 16 provides for IIoT applications, there is still a need for enhanced provisions for IIoT applications, such as enhancements to uplink and/or downlink scheduling.

Herein, the following documents are referenced:
[1] 3GPP TS 22.104 V16.5.0
[2] 3GPP TR 23.700

To meet the demand for wireless data traffic having increased since deployment of 4th generation (4G) communication systems, efforts have been made to develop an improved 5th generation (5G) or pre-5G communication system. The 5G or pre-5G communication system is also called a ‘beyond 4G network’ or a ‘post long term evolution (LTE) system’. The 5G communication system is considered to be implemented in higher frequency (mmWave) bands, e.g., 60 GHz bands, so as to accomplish higher data rates. To decrease propagation loss of the radio waves and increase the transmission distance, beamforming, massive multiple-input multiple-output (MIMO), full dimensional MIMO (FD-MIMO), array antenna, analog beamforming, and large scale antenna techniques are discussed with respect to 5G communication systems. In addition, in 5G communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancellation and the like. In the 5G system, hybrid frequency shift keying (FSK) and Feher's quadrature amplitude modulation (FQAM) and sliding window superposition coding (SWSC) as an advanced coding modulation (ACM), and filter bank multi carrier (FBMC), non-orthogonal multiple access (NOMA), and sparse code multiple access (SCMA) as an advanced access technology have been developed.

The Internet, which is a human centered connectivity network where humans generate and consume information, is now evolving to the Internet of things (IoT) where distributed entities, such as things, exchange and process information without human intervention. The Internet of everything (IoE), which is a combination of the IoT technology and the big data processing technology through connection with a cloud server, has emerged. As technology elements, such as “sensing technology”, “wired/wireless communication and network infrastructure”, “service interface technology”, and “security technology” have been demanded for IoT implementation, a sensor network, a machine-to-machine (M2M) communication, machine type communication (MTC), and so forth have been recently researched. Such an IoT environment may provide intelligent Internet technology services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing information technology (IT) and various industrial applications.

In line with this, various attempts have been made to apply 5G communication systems to IoT networks. For example, technologies such as a sensor network, MTC, and M2M communication may be implemented by beamforming, MIMO, and array antennas. Application of a cloud RAN as the above-described big data processing technology may also be considered to be as an example of convergence between the 5G technology and the IoT technology. As described above, various services can be provided according to the development of a wireless communication system, and thus a method for easily providing such services is required.

### SUMMARY

It is an aim of certain examples of the present disclosure to provide approaches for enhancing and/or optimising uplink scheduling and transmissions in 3rd Generation Partnership Project 5th Generation Systems (3GPP 5GS).

According to a first aspect of the present disclosure, a method of a terminal for performing uplink communications with an access point in a mobile communications system is provided. The method comprises transmitting uplink data of an application to the access point based on a first set of uplink transmission parameters; detecting a trigger condition for entry into a survival time state for the application, and if the trigger condition is detected, entering into a survival time state for the application, and when in the survival time state for the application, transmitting uplink data of the application to the access point based on a second set of uplink transmission parameters.

Applying the concept of a survival time to the uplink of a radio access network (RAN) allows uplink transmissions associated with an application to be modified based on the survival time associated with the application. In turn, this means that uplink transmissions can be modified to reduce the likelihood that a communication service will be considered unavailable for the application or to resource requirements/increase efficiency. The use of the concept of a survival time in the uplink of a RAN may also lessen reliance on smart scheduling in the RAN.

In an example of the present disclosure, the method further comprises, when in the survival time state for the application, detecting an exit condition for exiting the survival time state for the application, and if the exit condition is detected, exiting the survival time state for the application and transmitting uplink data of the application based on the first set of uplink transmission parameters or an updated first set of uplink transmission parameters.

In another example of the present disclosure, the exit condition for exiting the survival time state for the application includes one or more of: an expiry of a survival time timer set to a survival time for the application, receiving feedback information on the success or failure of an uplink transmission for the application, receiving a command for exiting the survival time state from the access point, receiving a command for exiting the survival time state through non-access stratum signalling, an estimation by the terminal that increased resilience uplink transmissions are not required for the application, an estimation by the terminal that decreased resilience uplink transmissions are not required for the application, and transmission of a predetermined number of packets for the application.

In another example of the present disclosure, the trigger condition for entry into the survival time state includes one of more of: receiving feedback information indicating the success or failure of an uplink transmission for the application, receiving feedback information indicating the success or failure of an uplink transmission for the application within or outside a given time window, receiving a status enquiry request, receiving a command for entering the survival time state from the access point, a start of a survival time timer, receiving a command for entering the survival time state through non-access stratum signalling, an estimation by the terminal that increased resilience uplink transmissions are required for the application, and an estimation by the terminal that decreased resilience uplink transmissions are required for the application.

Controlling entry to and/or exit from the survival time state based upon the above criteria enables modifications to be applied to uplink transmissions for an application when there is an indication that the performance/reliability of uplink transmissions are satisfactory, have improved, are expected to improve, have deteriorated, or are expected to deteriorate. Consequently, the modifications applied can be appropriately targeted towards increasing or decreasing the resilience of uplink transmissions.

In another example of the present disclosure, feedback information from the access point on the success or failure of an uplink transmission for the application includes one or more of: a Radio Link Control, RLC, ACK, an RLC NACK, an absence of an RLC ACK, an absence of an RLC NACK, Downlink Control Information, DCI, indicating a request for retransmission of a packet, and DCI not indicating a request for retransmission of a packet.

In another example of the present disclosure, receiving the command includes receiving a command in a Media Access Control, MAC, Control Element, CE.

In another example of the present disclosure, a status enquiry request includes one or more of a RLC polling flag set by the access point, and a RLC polling flag set by the terminal.

The use of existing feedback mechanisms/signalling between the access point and the terminal enables the concept of the survival time to be applied to the uplink of the RAN with little additional and/or new signalling.

In another example of the present disclosure, the second set of uplink transmission parameters is modified with respect to the first set of uplink transmission parameters to increase or decrease the resilience of uplink transmissions for the application.

In another example of the present disclosure, if the trigger condition is the receipt of feedback information indicating the failure of an uplink transmission for the application, the second set of uplink transmission parameters is modified with respect to the first set of uplink transmission parameters to increase the resilience of uplink transmissions for the application.

In another example of the present disclosure, if the trigger condition is the receipt feedback information indicating the success of an uplink transmission, the second set of uplink transmission parameters is modified with respect to the first set of uplink transmission parameters to decrease the resilience of uplink transmissions for the application.

The dependence of the type of modification to the uplink transmissions on whether the feedback relates to the success or failure an uplink transmission enables appropriate modifications to be applied. For example, if the feedback indicates the failure of a transmission (e.g. a NACK), the resilience of uplink transmissions is increased to reduce the likelihood that following or ongoing uplink transmissions will fail and the communication service for the application deemed to be unavailable. Conversely, if the feedback indicates the success of a transmission (e.g. an ACK), this may allow for the resilience of uplink transmissions to be reduced while in the survival time state, without significantly increasing the likelihood that the communication service for the application will be deemed unavailable.

In another example of the present disclosure, modifications to increase the resilience of uplink transmissions includes using one or more of packet duplication, reduced order modulation, a different modulation scheme, a reduced code rate, increased strength error detection/correction, changed HARQ process parameters, increased transmission power, optimised resource selection, transmissions to multiple access points, beamforming, multi-antenna transmission, relaying, and multi-path transmission.

In another example of the present disclosure, modifications to decrease the resilience of uplink transmissions includes one or more of restricting packet duplication, restricting uplink transmissions to primary and/or secondary access points, restricting repeated transmissions, restricting transmissions to a subset of available antennas, restricting multi-antenna transmission, restricting use of beamforming, restricting use of relaying, restricting use of multipath transmission, modulation restrictions, coding restrictions, restricting cooperation between cells, restricting transmission powers, restricting transmissions that cause interference to other users of the RAN, restricting resources types that are used for transmissions, and restricting transmissions based on channel conditions or other conditions at the terminal.

In another example of the present disclosure, the modifications are predetermined, indicated to the terminal by the access point, indicated to the terminal via higher layer signalling, or determined by the terminal.

In another example of the present disclosure, if the trigger condition is an estimation by the terminal that increased resilience uplink transmissions are required for the application or an estimation by the terminal that decreased resilience uplink transmissions are required for the application, the method further includes transmitting an indication to the access point that the terminal has entered the survival time state.

In another example of the present disclosure, the estimations are based on one or more of received signal strength, feedback from the access point including channel state information, measurement of packet errors rates in a given time window, past radio link performance, the type of application, application-related measurements including imminent expiry of packets or buffer overflow.

In another example of the present disclosure, the method further comprises, in response to entering the survival time state, setting a timer to a survival time for the application and starting the timer, and wherein the exit condition for the application is expiry of the timer.

This allows for the modification of the uplink transmissions parameters to be dependent on the survival time for the application and/or synchronised with the survival time utilised by the core network.

In another example of the present disclosure, the survival time is determined by the terminal based on one or more of an indication received from the access point, an indication received via higher layer signalling, or information stored at the terminal.

In another example of the present disclosure, the network performance for the application during the survival time state is used by the core network of the mobile communications system to determine the availability of a communications service for the application.

In another example of the present disclosure, the mobile communications system is a 3GPP compliant 5G New Radio mobile communications system.

According to a second aspect of the present disclosure, a terminal for performing uplink communications with an access point in a mobile communications system, the terminal comprising a controller and a transceiver, wherein the controller and the transceiver are configured to perform the method according any preceding aspect or example.

According to another aspect of the present disclosure there is provided a computer readable storage medium having stored thereon computer executable instructions which when executed by a computer cause the computer to perform any of the above methods.

### BRIEF DESCRIPTION OF THE DRAWINGS

Embodiments of the present disclosure are further described hereinafter with reference to the accompanying drawings, in which:

FIGS. 1A and 1B illustrate the concept of a survival time in a 5G mobile communications network.

FIG. 2 provides an example implementation of a survival time at a terminal for the uplink of a Radio Access Network (RAN) of a 5G mobile communications system.

FIG. 3 provides an example implementation of a survival time at a terminal for the uplink of a Radio Access Network (RAN) of a 5G mobile communications system.

FIG. 4 provides an example implementation of a survival time at a terminal for the uplink of a Radio Access Network (RAN) of a 5G mobile communications system.

FIG. 5 provides an example implementation of a survival time at a terminal for the uplink of a Radio Access Network (RAN) of a 5G mobile communications system.

FIG. 6 provides an example implementation of a survival time at a terminal for the uplink of a Radio Access Network (RAN) of a 5G mobile communications system.

FIG. 7 provides an example implementation of a survival time at a terminal for the uplink of a Radio Access Network (RAN) of a 5G mobile communications system.

FIG. 8 provides a schematic diagram of a terminal in accordance with an example of the present disclosure.

FIG. 9 provides a schematic diagram of a base station in accordance with an example of the present disclosure.

FIG. 10A provides an example implementation of a survival time in a Radio Access Network (RAN) of a 5G mobile communications system.

FIG. 10B provides an example implementation of a survival time in a Radio Access Network (RAN) of a 5G mobile communications system.

FIG. 11 provides an example implementation of a survival time in a RAN of a 5G mobile communications system.

FIG. 12 provides an example implementation of a survival time in a RAN of a 5G mobile communications system.

### DETAILED DESCRIPTION

The following description with reference to accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

While describing the embodiments, technical content that is well known in the related fields and not directly related to the disclosure will not be provided. By omitting redundant descriptions, the essence of the disclosure will not be obscured and may be clearly explained.

For the same reasons, components may be exaggerated, omitted, or schematically illustrated in drawings for clarity. Also, the size of each component does not completely reflect the actual size. In the drawings, like reference numerals denote like elements.

As used herein, the term “and/or” includes any and all combinations of one or more of the associated listed items. Expressions such as “at least one of,” when preceding a list of elements, modify the entire list of elements and do not modify the individual elements of the list. Throughout the disclosure, the expression “at least one of a, b or c” indicates only a, only b, only c, both a and b, both a and c, both b and c, all of a, b, and c, or variations thereof.

Advantages and features of one or more embodiments of the disclosure and methods of accomplishing the same may be understood more readily by reference to the following detailed description of the embodiments and the accompanying drawings. In this regard, the present embodiments may have different forms and should not be construed as being limited to the descriptions set forth herein. Rather, these embodiments are provided so that this disclosure will be thorough and complete and will fully convey the concept of the present embodiments to one of ordinary skill in the art, and the disclosure will only be defined by the appended claims.

Here, it will be understood that combinations of blocks in flowcharts or process flow diagrams may be performed by computer program instructions. Since these computer program instructions may be loaded into a processor of a general purpose computer, a special purpose computer, or another programmable data processing apparatus, the instructions, which are performed by a processor of a computer or another programmable data processing apparatus, create units for performing functions described in the flowchart block(s). The computer program instructions may be stored in a computer-usable or computer-readable memory capable of directing a computer or another programmable data processing apparatus to implement a function in a particular manner, and thus the instructions stored in the computer-usable or computer-readable memory may also be capable of producing manufacturing items containing instruction units for performing the functions described in the flowchart block(s). The computer program instructions may also be loaded into a computer or another programmable data processing apparatus, and thus, instructions for operating the computer or the other programmable data processing apparatus by generating a computer-executed process when a series of operations are performed in the computer or the other programmable data processing apparatus may provide operations for performing the functions described in the flowchart block(s).

In addition, each block may represent a portion of a module, segment, or code that includes one or more executable instructions for executing specified logical function(s). It should also be noted that in some alternative implementations, functions mentioned in blocks may occur out of order. For example, two blocks illustrated consecutively may actually be executed substantially concurrently, or the blocks may sometimes be performed in a reverse order according to the corresponding function.

Here, the term “unit” in the embodiments of the disclosure means a software component or hardware component such as a field-programmable gate array (FPGA) or an application-specific integrated circuit (ASIC) and performs a specific function. However, the term “unit” is not limited to software or hardware. The “unit” may be formed so as to be in an addressable storage medium, or may be formed so as to operate one or more processors. Thus, for example, the term “unit” may refer to components such as software components, object-oriented software components, class components, and task components, and may include processes, functions, attributes, procedures, subroutines, segments of program code, drivers, firmware, micro codes, circuits, data, a database, data structures, tables, arrays, or variables. A function provided by the components and “units” may be associated with a smaller number of components and “units”, or may be divided into additional components and “units”. Furthermore, the components and “units” may be embodied to reproduce one or more central processing units (CPUs) in a device or security multimedia card. Also, in the embodiments, the “unit” may include at least one processor. In the disclosure, a controller may also be referred to as a processor.

A wireless communication system has evolved from providing initial voice-oriented services to, for example, a broadband wireless communication system providing a high-speed and high-quality packet data service, such as communication standards of high speed packet access (HSPA), long-term evolution (LTE) or evolved universal terrestrial radio access (E-UTRA), and LTE-Advanced (LTE-A) of 3GPP, high rate packet data (HRPD) and ultra mobile broadband (UMB) of 3GPP2, and IEEE 802.16e. A 5th generation (5G) or new radio (NR) communication standards are being developed with 5G wireless communication systems.

Hereinafter, one or more embodiments will be described with reference to accompanying drawings. Also, in the description of the disclosure, certain detailed explanations of related functions or configurations are omitted when it is deemed that they may unnecessarily obscure the essence of the disclosure. All terms including descriptive or technical terms which are used herein should be construed as having meanings that are obvious to one of ordinary skill in the art. However, the terms may have different meanings according to an intention of one of ordinary skill in the art, precedent cases, or the appearance of new technologies, and thus, the terms used herein have to be defined based on the meaning of the terms together with the description throughout the specification. Hereinafter, a base station may be a subject performing resource assignment of a terminal, and may be at least one of a gNode B, an eNode B, a Node B, a base station (BS), a wireless access unit, a base station controller, and a node on a network. A terminal may include user equipment (UE), a mobile station (MS), a cellular phone, a smart phone, a computer, or a multimedia system capable of performing communication functions, or the like. In the disclosure, a DL is a wireless transmission path of a signal transmitted from a base station to a terminal, and a UL is a wireless transmission path of a signal transmitted from a terminal to a base station. Throughout the specification, a layer (or a layer apparatus) may also be referred to as an entity. Also, hereinbelow, one or more embodiments of the disclosure will be described as an example of an LTE or LTE-A system, but the one or more embodiments may also be applied to other communication systems having a similar technical background or channel form. For example, 5G mobile communication technology (5G, new radio, NR) developed after LTE-A may be included. In addition, the one or more embodiments may be applied to other communication systems through some modifications within the scope of the disclosure without departing from the scope of the disclosure according to a person skilled in the art.

In an LTE system as a representative example of the broadband wireless communication system, an orthogonal frequency division multiplexing (OFDM) scheme is used in a DL and a single carrier frequency division multiplexing (SC-FDMA) scheme is used in a UL. The UL refers to a wireless link through which a terminal, UE, or a MS transmits data or control signals to a BS or a gNode B, and the DL refers to a wireless link through which a BS transmits data or control signals to a terminal. In such a multiple access scheme, data or control information of each user is classified by generally assigning and operating the data or control information such that time-frequency resources for transmitting data or control information for each user do not overlap each other, that is, such that orthogonality is established.

Terms such as a physical channel and a signal in an existing LTE or LTE-A system may be used to describe methods and apparatuses suggested in the disclosure. However, the content of the disclosure is applied to a wireless communication system, instead of the LTE or LTE-A system.

The Internet of Things (IoT) comprises smart sensors collaborating directly without human involvement. There are myriad proprietary and standardized IoT connectivity solutions, with widely varying coverage area/connection range, Quality of Service (QoS) guarantees, reliability, and cost. Standardized, wide-area (cellular) based solutions are especially important for Industrial Internet of Things (IIoT), which is a key component of the envisaged fourth industrial revolution (Industry 4.0).

Accordingly, Release 16 of the New Radio (NR) standards (e.g. 3GPP TS 22.104 V16.5.0) provides targeted support for services such as the IIoT, which may include factory automation, electric power distributions and audio/video streaming for example. However, there is still a need for further enhancements. One particular area where enhancements may be realised is scheduling for the uplink and downlink, such that scheduling takes improved account of QoS requirements such as latency and jitter, and may lessen reliance on a network's implementation of smart scheduling. In accordance with the present disclosure, enhanced approaches to uplink scheduling and transmissions may be achieved by applying the concept of a survival time to the Radio Access Network (RAN) between devices of a 5G NR mobile communications system, such as between the base stations and terminals of a 5G NR mobile communications system.

Examples in accordance with the present disclosure will now be described in the context of a 5G wireless communication network, and in particular a NR RAN forming part of a 5G wireless communication network. However, it will be understood that the present disclosure is not limited to any particular radio access technology. Furthermore, although communications between terminals and base stations are primarily considered, the approaches set out may be applied to communications concerning other types of devices that may communicate with a terminal or base station, including other terminals, relay nodes, access points, and terminals outside of a 5G NR mobile communications system. The term access point may also be used to refer to any entity that a terminal may transmit uplink data to or via.

References to particular 3GPP constructs in certain examples should not be understood as limiting the ability of examples of the present disclosure to be applied to other wireless communication networks. Furthermore, although the Industrial Internet of Things (IIoT) is primarily referred to, the techniques disclosed herein are not limited to such applications and may be applied to any application of 5G NR systems.

### Application Survival Time

The concept of a survival time is defined in 3GPP TS 22.104 16.5.0 as “the time that an application consuming a communication service may continue without an anticipated message”. In other words, the maximum survival time indicates the time period the communication service may not meet an application's (e.g. usage scenario's) requirement before the communication service is deemed to be in an unavailable state, where different applications may include factory automation, electricity grid control, and motion control for example. Applications may also be represented by particular types of terminals or other elements of a top layer or application layer, and reception of a message may refer to reception of a message or data associated with the application at either end of a communication path. The communication service is considered unavailable for an application if an expected message is not received by the application within a specified time, which, at minimum, is the sum of maximum allowed end-to-end latency and the specified survival time. In other words, the survival time indicates to the communication service the time available to recover from failure. In a sense, it represents the difference between reliability of a network, and availability of a communication service.

More generally, the survival time is a concept within the core network and is a time that a communications service or link via the mobile communications network for a specific application is deemed to be available regardless of whether an anticipated message for the application due to be communicated during the time period is successfully communicated or not. Consequently, if an expected communication time of a message for an application is within a survival time associated with the application, the deemed availability of the communication service for the application over the mobile communications network is not affected by a failure to communicate the expected message. In other words, the communication status of messages (i.e. failure or success) with respect to determination of the availability of a communication service may be disregarded when their expected communication time falls within the survival time.

The value of a survival time may vary depending on the nature of the application and its requirements. For example, an application that requires a high Quality of Service (QoS) may have a relatively short survival time compared to its frequency of expected communications/messages, whereas an application that has a low QoS requirement may have a relatively long survival time. Various different survival times for a range of terminal scenarios and applications are set out in 3GPP TS 22.104 16.5.0.

Although a survival time is referred to throughout this disclosure, other suitable labels may be used to identify such a time period, for example, a numeric label for the time period or associated timer.

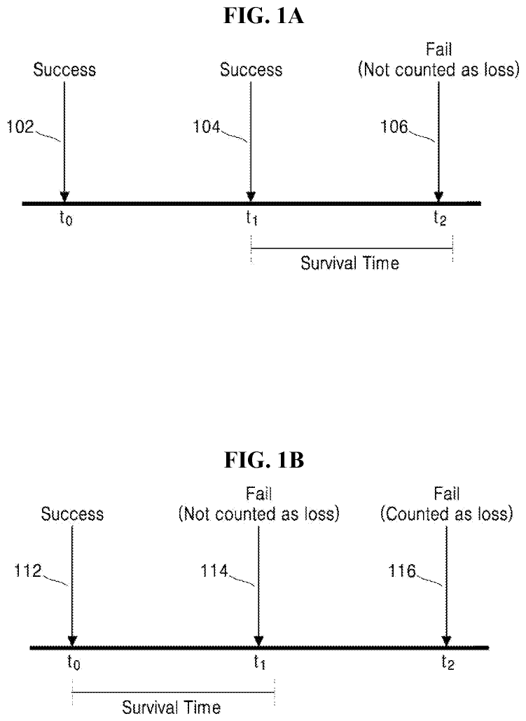

FIGS. 1A and 1B illustrate the concept of a survival time in a 5G NR mobile communications system.

In FIG. 1A, messages for particular application are expected to be received at t0, t1, and t2. A first message 102 is successfully received at t0, a second message 104 is successfully received at t1 but the third message at t2 is not successfully received. However, because the time t2 at which the message 106 is expected to be received falls within the survival time from time t1, although the message 106 is not successfully received, the availability of the service is not affected. In other words, the loss of message 106 at time t2 is not considered as a loss in the determination of the availability of the service, thus the availability of service is not affected when an expected message is not successfully received during the survival time. Therefore, if a fourth message expected to be received at time t3 is successfully received, the availability of the service will not be affected by the loss of message 104.

In FIG. 1B, messages 112, 114, and 116 are expected to be received at t0, t1, and t2 as in FIG. 1A, however, in addition to message 116, message 114 is also not successfully received. Message 114 is not considered as a loss in the determination of the availability of the service since its expected reception time falls within the survival time from the last successful message reception at t0. However, message 116 is considered to be lost since its expected reception time t2 falls outside of the survival time started at t0. Consequently, based on the failure to receive message 116 outside of the survival time, the service will be determined to not be available, where the determination may be performed by the application or terminal itself, a network entity in charge of monitoring and determining network metrics, or via cross-layer communication between the application and network based on a Service Level Agreement (SLA).

In other words, the availability of service is affected when an expected message is failed to be received at a time outside the survival time, which in the case of FIG. 1B is measured from the last successful reception of a message i.e. the failure to receive the message occurs when the survival time has expired/no longer running. Consequently, the survival time provides an indication of a service's tolerance to lost messages. For example, when the survival time is set as less than the period between the expected reception of messages for an application and starts at the reception time of a message, the communication service being used by the application will be determined to be unavailable whenever an expected message is not received. In contrast, when the survival time is larger than the time between the expected reception of messages, failure to receive one or more messages may be tolerated and thus the availability of the communication service may not be affected. If a communication service is determined to be unavailable for an application, a terminal or the controlling party may implement certain contingency measure to lessen any adverse effects of the loss of availability of the communications service.

In 3GPP TS 22.104 16.5.0 survival time is considered to be a higher layer concept and is used to determine whether a communication service is available for a corresponding application. In turn, the availability of a communication service may be used to assess compliance with SLAs by higher layers, and as a possible indication of a need to increase network reliability if such SLAs are not being met.

3GPP TR 23.700 proposes the application of the survival time to the RAN, and in particular, the RAN uplink. However, beyond the recognition that the survival time should be considered in the context of uplink RAN communications, the impact of survival times upon the RAN uplink and its application to the RAN uplink has not been considered.

In addition to a survival time being used to calculate the availability of a communications service for an application, it may be considered to be an indication of whether transmission/reception of a message/packet may be skipped or loss of a message/packet tolerated without affecting the availability of the communication service for an application. For example, with respect to FIG. 1A, the transmission of message 106 may be skipped if the survival time has not expired, and as long as the next message at T3 is successfully received, the availability of the communication service for the application will not be affected. Consequently, there is scope for applying the concept of a survival time to a RAN of systems such as 5G NR systems in order to leverage the flexibility that the survival time provides in terms of selecting which communications should and should not take place and controlling the resilience and resource utilisation of such communications without affecting the availability of the respective communication service. The implementation of the survival time in the uplink of the RAN may therefore lead to, among others, advantages such as enhanced uplink scheduling, reduced reliance on smart scheduling, reduced resource utilisation by certain applications and their associated communications, reduced interference, increased resource availability for other communications, and reduced power consumption at terminals for example. Furthermore, given the use of the survival time in the determination of communication service availability for an application, implementation of the survival time at the uplink of the RAN may also enable resilience enhancements to be selectively applied to uplink communications for an application, which in turn may reduce the likelihood of messages being failed to be received and thus a communication service being deemed to be unavailable for an application.

### Survival Time in the Radio Access Network

In accordance with the present disclosure, a survival time associated with an application may be used as a means to control the modification of the transmission of uplink data associated with the application over a RAN. For example, based on a survival time being configured or associated by the network with a service flow, a terminal may be considered to be in a survival time state (STS) with respect to the application with which the survival time is associated (e.g. whilst a survival timer associated with the application is running), and whilst in the STS, uplink transmissions from the terminal associated with the application may be modified in order to increase or decrease their resilience. For example, if the terminal derives (e.g. based on receiving) an indication that the reliability of the uplink has decreased or is expected to decrease, the resilience of uplink transmissions may be increased so as to reduce the likelihood of failed uplink transmissions, with the intention that the availability of the communication service for the application is maintained despite the decrease in network reliability. Alternatively, if the terminal derives (e.g. based on receiving) an indication that the reliability of the network uplink has increased or is expected to be maintained or increase, the resilience of uplink transmissions may be decreased or restrictions on uplink transmissions may be implemented, such that resources requirements at the terminal and/or RAN may be reduced without significantly increasing the likelihood of the communication service being deemed to be unavailable for the application. For example, uplink transmissions may still be successful despite the reduction in resilience due to the there being a sufficient gap between current uplink performance and required uplink performance, or the failure of an uplink transmission can be tolerated since it occurs within the survival time of the application and thus resilience can be reduced or a transmission skipped even though an uplink transmission failure may occur. In other words, the concept of a survival time for an application can be utilised in the uplink of a RAN to reduce the likelihood or a communication service being deemed unavailable for an application and/or to increase terminal and RAN efficiency/resource utilisation whilst maintaining the availability of the communication service for the application. In turn this can reduce the reliance on smart scheduling and other approaches to optimising of resource utilisation in the RAN.

Different survival times may be associated with different applications/usage scenarios and thus communications that are associated with an application/usage scenario. Throughout this disclosure, the term service flow is used to covers various different types of user data flows associated with an application/usage scenario that take place between a terminal and a base station. For example, a service flow may refer to Quality of Service (QoS) flow, a dedicated radio bearer (DRB), an individual logical channel, a logical channel or channels carrying data of a particular priority or having a priority below a particular threshold, a logical channel group, data of a certain type or having a certain priority, data associated with a specific application/usage scenario, data with a same final destination, or any other specified data bearer. However, the term service flow it is not only limited to these examples and may refer to any classification of data flows between devices and/or core network to which a survival time may be associated. Although it is envisaged that separate survival times will be associated with each service flow, survival times may be allocated to service flows that fulfil certain conditions, such a QoS requirement or priority requirement such that multiple service flows fulfilling a certain conditions may have a single survival time associated with them. Furthermore, although data transmitted via, on or in association with a service is flow is referred to through this disclosure, the described approaches are equally applicable to data packets or messages, such that the data transmissions associated with service flows may also be referred to as data packets or messages.

The survival time utilised in the RAN for a particular service flow is anticipated to correspond to that used by the core network/higher layers for the particular service flow or that set by the application corresponding to the service flow, such that the effect of uplink RAN transmission modifications based on a survival time (e.g. when the terminal is in the STS with respect to the service flow) may be anticipated by higher network layers. However, the present disclosure is not limited to the utilising a same survival time in the RAN and core network/higher layers. For example, the survival time utilised in a RAN may differ from that used by other entities in the network and/or the application associated with the service flow. For instance, a survival time utilised in the RAN may differ in order to account for factors such as latency and processing time associated with a RAN, or to ensure that a survival time utilised at the RAN is more stringent that that used to calculate availability of a communication service for the corresponding service flow. A survival time utilised by the RAN may also be pre-configured, configured through NAS signalling or higher layer signalling, or configurable by a terminal and/or base station. Alternatively, a common survival time may be used for all of or a subset of service flows at the terminal. In the event that a survival time is determined by or is required to be requested by the terminal, the terminal may indicate the determined survival time or make a request for a particular survival time to the base station.

When an indication of a survival time is provided to the terminal by the base station, the indication may include an actual value of the survival time or may include a survival time index which can be used to identify a survival time using a prestored table for example. Survival times for use in the RAN may also be preconfigured or reconfigured based on one or more of a complexity of the terminal (e.g. its processing, transmission, and reception capabilities), a number of antennas at the terminal, types of transmission modes supported by the terminal, a relay capability of the terminal, a current status of the terminal, and an application associated with the service flow or terminal, either with or without control of the base station.

A range of different types of RAN-based uplink transmission modifications to increase and decrease the resilience of uplink transmissions may be implemented whilst a terminal is in a STS. Once a terminal has exited a STS for a particular service flow or the terminal has exited a STS as a whole, the terminal may resume unmodified uplink transmissions, such that subsequent uplink transmissions are based on the same or an updated version of the transmission parameters used before entry into the STS.

With respect to increasing the resilience of uplink transmissions, one or more of the following modifications may be implemented: packet duplication (PDCP packet duplication), reduced order or different modulation, reduced code rate, improved error detection/correction including changes to HARQ process parameters, increased transmission power, and optimised resource selection.

With respect to reducing the resilience of transmissions, which may be used to provide efficiency enhancements or lessen reliance of smart scheduling etc., one or more of the following modifications may be implemented: suspending duplicated transmissions (PDCP packet duplication); controlling whether uplink transmissions are to primary and/or secondary (e.g. neighbouring) base stations or other RLC entities (e.g. relay nodes, terminals) etc.; restricting repeated transmissions when a first transmission is not successful; restricting transmissions to a subset of available antennas; restricting multi-antenna modes that can be used; restricting the use of beamforming; restricting use of relaying; restricting use of multipath transmission; restricting the modulation and coding that may be applied to transmissions; restricting cooperation between cells; restricting transmission powers; suspending transmissions that are likely to lead to increased interference to other users of the RAN; suspending transmissions that utilise particular types of resource grants e.g. dedicated, persistent, semi-persistent or aperiodic resource grants; suspending transmissions that may lead to clashes between granted resources; and selectively restricting or suspending transmissions based on channel conditions, application requirements or other conditions at the terminal.

With respect to the suspension of transmissions, data intended for transmission may be discarded or its transmission delayed. Alternatively, in some examples, whilst in a STS, the generation of data associated with the relevant service flow or other functionality of the terminal may be partially or fully restricted.

Although some of the modifications to the transmission behaviour of the terminal have been cast as restrictions, they may also be expressed as permissions. For example, certain behaviours may only be permitted when the terminal is not in a STS. Consequently, the types of restrictions set out above may be implemented in a permissive manner based on whether the terminal is in a STS.

These transmission modifications are merely particular examples, and therefore the modifications are not limited to these. Although specific approaches for increasing and decreasing the resilience have been set above, each modification is applicable to either, although implemented in an opposite manner. For example, if the normal transmission of data for a service flow does not include multiple antennas, multiple antennas may be used when the resilience of transmissions is to be increased.

The type of uplink transmission modifications to be implemented by a terminal and when they should be implemented may be preconfigured (e.g. with an indication of the configurations stored at the terminal), or an indication of when and what modifications to apply to a service flow may be indicated to the terminal by the base station or via higher layer signalling including NAS signalling. Alternatively, the terminal may select when and what uplink transmission modifications are to be implemented and then inform the base station accordingly. For example, the terminal may determine the modifications to apply based on indications established by the terminal itself, such as received signal strength, packet error rate, information received from the respective application and then determine the implementation of uplink transmission modifications accordingly.

The application of survival times to the uplink of a RAN may be considered to include three different aspects: the triggers for a terminal to apply uplink transmission modifications (i.e. when to enter a STS for a service flow); the modifications that a terminal performs (when in a STS), and the conditions to stop applying uplink transmission modifications (i.e. when to exit a STS). Each of these aspects are considered in turn and examples provided to illustrate how they may be combined and implemented in a 5G NR RAN.

Although the following description applies to the implementation of the survival time to the uplink of the RAN, a terminal is referred to being in a survival timer state (STS) or not being in a STS. It is envisaged that a terminal is in a STS for a service flow (i.e. application/usage scenario) when a survival time or survival timer is running at the terminal with respect to the service flow; however, in some examples a STS may not be related to a survival time or running timer and instead entry into and exit from a STS may be related to non-time-based criteria or a combination of time-based and non-time-based criteria.

Furthermore, although survival times are usually application specific, such that a terminal that supports multiple service flows may handle multiple survival times and be in different STSs with respect to the service flows (e.g. a terminal may be in a STS with respect to a first service flow but not in a STS with respect to a second service flow), the present disclosure is not so limited, such that a survival time may apply to a terminal as a whole or a sub-set of service flows/radio bearers/logical channels even though the terminal supports a number of different service flows. For example, based on a survival time of a specific application, the resilience of all uplink user data transmissions may be modified, such that the terminal may be considered to be in a STS rather than with respect to only the specific application. However, in examples where a terminal supports only a single application, entry into a STS may inherently mean the terminal as a whole enters the STS. Consequently, although only a single STS is considered for simplicity in the examples provided below, reference to the terminal being in a STS is referring to the processing and transmissions with respect to a particular service flow. However, the disclosure is not limited to only this implementation, and it is also possible that a STS refers to the terminal as a whole or more than one service flow, such that there may not be separate STSs for each individual service flow.

Entry into a Survival Time State

Motivations for the application of survival times to the RAN include, among others, reducing the likelihood that a communication service is deemed to be unavailable for a service flow when network and RAN conditions deteriorate, and increasing efficiency/reducing resource requirements across the RAN and/or terminal when network and RAN conditions allow without substantially affecting the availability of the communication service for the service flow. For example, the resilience of uplink transmissions for a service flow may be increased to reduce the likelihood that a communication service is deemed to be unavailable for the service flow when network and RAN conditions deteriorate, and the resilience of uplink communications for a service flow may be reduced to improve efficiency if network and RAN conditions allows for resilience to be reduced whilst maintaining the availability of the a communication service for the service flow. Consequently, trigger conditions for entry into a STS are envisaged to be based on events or indications that are related to the past, current, or future state of the RAN, uplink transmissions, and the terminal so that the terminal can enter a STS when the aforementioned advantages may be realised; however, trigger conditions may also be related to the application itself, for example, a requirement for increased reliability communications during a given time period.

A first type of trigger condition for entry into a STS is the receipt of a feedback signal by a terminal from a base station indicating the success and/or failure of an uplink transmission either related to or unrelated to the service flow. In particular, a terminal is configured to enter into a STS for a service flow when a Radio Link Control (RLC) ACK and/or NACK associated with a previous uplink transmission is received from the base station. When the feedback is related to the service flow, it can be considered to provide information on the current and/or future state of communications with respect to the service flow e.g. whether the most recent message for the service flow has been successfully communicated and/whether a future message is likely to be successfully communicated. When the feedback is unrelated to the service flow, it can be considered to provide information on an future state of communications for the service flow e.g. whether a future message is likely to be successfully communicated.

When the RLC is operating in the Acknowledge Mode (AM), the receipt of an RLC ACK indicating a successful uplink transmission may be used as an indication that modifications to utilise reduced resilience uplink transmissions may be implemented to achieve efficiency advantages etc. without jeopardising the availability of a communication service for the service flow. Alternatively or additionally, the receipt of an RLC NACK indicating an unsuccessful uplink transmission may be used as an indication that modifications to utilise increased resilience uplink transmission should be implemented to increase the likelihood that future transmissions will be successful, thus reducing the likelihood that the communication service for the service flow will be deemed to be unavailable.

As well as the receipt of an RLC ACK or NACK, the absence of an expected RLC ACK or the absence of a NACK can also be used as a trigger condition for entry into a STS. Similarly, the late receipt of an ACK (i.e. outside a specified time window or once a timer associated with an uplink transmission has expired) or an accumulated delay reaching a threshold may be considered to be a trigger condition for a terminal to enter a STS in which uplink transmissions are modified to increase their resilience. Although it is envisaged that the receipt or absence of a single RLC ACK or NACK may trigger entry into a STS, the trigger may be the receipt or absence of a plurality of or consecutive RLC ACKs or NACKs.

A second type of trigger condition for entry into a STS is the transmission or receipt of a status enquiry. In particular, a terminal may be configured to enter into a STS for a service flow when an RLC polling flag is set by the base station or the terminal, where the RLC polling flag is associated with a radio bearer carrying the service flow or one or more service flows including the respective service flow. Alternatively, the STS may be entered into in response to the content of a Status PDU transmitted/received in response to the setting of a RLC polling flag. In another example, the reception of a buffer status report or a request for a buffer status report may act as a trigger condition for a terminal to enter a STS.

A third type of trigger condition for entry into a STS is the receipt of an explicit request for the terminal to enter a STS for a service flow. In particular, a terminal may be configured to enter into a STS in response to one or more of an explicit indication or request from the base station, an indication received via Non-Access Stratum (NAS) signalling, and a request received from the service flow (i.e. application) itself. For example, the receipt of a dedicated or repurposed Media Access Control (MAC) Control Element (CE) from a base station may be used to trigger the terminal to enter a STS. By virtue of enabling the base station or higher layers to control entry of a terminal into a STS, it is possible for entry into a STS to be based on information that may not be available at the terminal or is more promptly available at the base station or the core network, such as information on network loading, channel conditions, changing QoS service requirements etc. Such indications or requests may also include an indication of whether the terminal should implement resilience enhancing or reducing modifications to its uplink transmissions.

With respect to entering a STS in response to a request received from the service flow (i.e. application) itself, this may occur when the application detects conditions that require improved reliability communications. For example, if the application is a sensing application or industrial control, if an emergency situation is detected, the application can request that the terminal enter a STS in which uplink transmission resilience is increased is entered into in order to improve the likelihood of uplink messages being successfully transmitted. Alternatively, a request may be received by the application from the destination entity i.e. the entity or organisation that is the ultimate destination of the uplink data. In turn the application may then request the terminal to enter the STS.

A fourth type of trigger condition for entry into a STS is an indication that is inferred by the terminal from communications received from the base station. In current 5G NR specifications, HARQ is not implemented for uplink user data transmissions (i.e. those transmitted in the Physical Uplink Shared Channel (PUSCH)), and therefore ACKs/NACKs are not available at this level of granularity. However, the content of Downlink Control Information (DCI) may be used to infer whether an uplink transmission was successfully received by the base station, and thus used as a trigger for a terminal to enter into a STS. In particular, if a New Data Indicator (NDI) is not toggled compared to a previous transmission for the HRAQ process, it may be inferred that the previous transmission was not successful and that the subsequent transmission is in fact a retransmission whereby soft combining should be performed. Conversely, if the NDI is toggled for a certain period of time compared to a previous transmission for the same HARQ process, it may be inferred that the previous transmission was successful and that the receive buffer should be flushed before loading the new user data.

The use of DCI in this manner may also allow a more prompt indication of the successful/unsuccessful receipt of an uplink transmission to be obtained compared to the use of RLC ACK/NACKs. Consequently, the use of DCI-based feedback may be useful in situations where a terminal may be in a STS for only a short period of time, such as when relatively short survival times are implemented, since a short survival time used at a network level to determine the availability of a communication service may expire before an RLC ACK/NACK is received by a terminal and thus before the terminal can enter into a STS and modify its uplink transmissions accordingly.

To account for instances where a terminal is required to enter a STS with little delay, as an alternative to the use of DCI, new signalling such as MAC signalling, RRC signalling, or signalling at higher layers including NAS signalling providing feedback on uplink transmissions may also be defined. Such a feedback mechanism may be also be required for scenarios where latency requirements are very strict.

A fifth type of trigger condition for entry into a STS is based on information that is not transmitted by the base station. In particular, a terminal may unilaterally enter a STS based on the result of a determination performed at the terminal rather than in response to specific feedback or indication received from the base station or core network. For example, the terminal may determine that it should enter a STS based on channel measurements performed by the terminal (e.g. based on a received signal strengthen indicator) or an evaluation of the success of previous packet deliveries for unrelated service flows. This type of trigger condition is similar to that set out under the third type condition in which the application itself requests entry of the terminal into the STS.

In the event that entry into a STS is based on the result of a determination at the terminal, the base station may not be aware that the terminal has entered into a STS and that transmission modifications will be applied. Consequently, in conjunction with this fifth type of trigger, the terminal can signal to the base station that it has entered a STS for a particular service flow and/or the transmission modifications that are to be implemented. The terminal can perform this signalling using existing uplink signalling mechanisms, by piggy backing on existing signalling, or new signalling may be defined for the purpose of indicating entry into a STS and/or transmission modifications the terminal will be applying to uplink transmissions.

A sixth type of trigger condition is the establishment of a new service flow i.e. communications for a new application. For example, a terminal may enter a STS as soon as a respective service flow has been established, such that substantially all uplink transmissions associated with the service flow are modified with respect to standard uplink transmission. The decision for a terminal to directly enter into a STS upon the establishment of a service flow or for a terminal to be permanently in a STS with respect to a service flow may for example be based on the requirements of the service flow or the past performance of the network with respect to the service flow or similar service flows. Alternatively, a terminal may enter into a STS for service flows that are associated with communications across a particular logical channel.

A range of different type of trigger conditions have been set out above; however, potential trigger conditions are not only limited to these and may take any suitable form, for example, a STS may be entered into when a battery level at the terminal is equal to or below a predetermined level such that power can be conserved at the terminal by making reduced resilience transmissions. In another example, a terminal may enter into a STS accordingly to a predetermined schedule provide by the base station or application. Other forms of trigger condition may include for example a protocol data unit (PDU) submission associated with the service flow to a lower layer or an arrival of a service data unit (SDU) associated with the relevant service flow from a higher layer

Although the foregoing types of trigger conditions and the examples thereof have been considered independently, one or more may also be used in conjunction with one another, such that there may be one or multiple trigger conditions for entering into a STS and the trigger condition(s) for entering a STS for different service flows may vary. For example, the specific trigger conditions for a service flow may be selected based on the type of service flow (i.e. the usage scenario), the value of a survival time associated with a service flow, latency requirements of a service flow, or network operator preference.

If the STS is associated with a particular survival time, a timer may be initialised with the particular survival time and started upon detection of a trigger condition. As set out above, each service flow may have an associated survival time, and therefore each service flow may have an associated survival timer. Such timers may be initialised upon establishment of a service flow or when an indication of the survival time for a service flow is acquired, for example, via NAS signalling, and then started upon detection of a trigger condition. Alternatively, the initialisation and starting of a timer may occur in response to detection of a trigger condition. In some examples, entry in to a STS or initialising of a timer may not occur immediately in response to a relevant trigger condition but be started in synchronisation with that of the base station or higher layers, so that the survival times are synchronised throughout the network.

### Actions Performed During Survival Time State

Upon detection of a relevant trigger condition, a terminal may enter into a STS, and when in the STS, one or more modifications to uplink transmissions or processing at the terminal may be implemented depending on one or more of the type of trigger condition, the network configuration, and the terminal configuration.

When the terminal has entered into a STS in response to a trigger condition associated with the failure of an uplink transmission, the anticipated failure of an uplink transmission, or a requirement for improved reliability transmissions, the terminal is configured to modify its uplink transmissions in any of the ways described above to increase their resilience. For example, the terminal may implement one or more of packet duplication (PDCP packet duplication), reduced order or different modulation, reduced code rate, improved error detection/correction, increased transmission power, optimised resource selection, controlling whether uplink transmissions are to primary and/or secondary (e.g. neighbouring) base stations or other RLC entities (e.g. relay nodes, terminals) etc., expanding or optimising the number of antennas that are used, beamforming, optimising the use of multipath transmission, implementing inter-cell cooperation, and optimising transmissions based on channel conditions or other conditions at the terminal.

When the terminal has entered into a STS in response to a trigger condition associated with the success of an uplink transmission, the anticipated success of uplink transmissions, or the opportunity to relax transmission resilience/reliability, the terminal may modify its uplink transmissions in any of the ways described above to reduce their resilience and/or conserve network/terminal resources. For example, the terminal may implement one or more of suspending duplicated transmissions (PDCP packet duplication), controlling whether uplink transmissions are to primary and/or secondary (e.g. neighbouring) base stations or other RLC entities (e.g. relay nodes, terminals) etc., restricting repeated transmissions when a first transmission is not successful, restricting transmissions to a subset of available antennas, restricting multi-antenna modes that can be used, restricting the use of beamforming, restricting use of relaying, restricting use of multipath transmission, restricting the modulation and coding that may be applied to transmissions, restricting cooperation between cells, restricting transmission powers, suspending transmissions that are likely to lead to increased interference to other users of the RAN, suspending transmissions that utilise particular types of resource grants e.g. dedicated, persistent, semi-persistent or aperiodic resource grants, suspending transmissions that may lead to clashes between granted resources, selectively restricting transmissions based on channel conditions or other conditions at the terminal, and newly received data for the service flow intended for transmission (e.g. newly arrived packet data convergence protocol (PDCP) SDUs) may be discarded or stored for transmission at a later time. In another example, the terminal may be instructed by the base station to suspend the provision of data intended to be transmitted to the base station during a STS, which may lead to improvements in energy consumption or radiated power at the terminal or interference to other users.

The modifications to uplink transmissions may be made until the terminal exits the STS or until a predetermined condition is met, for example, a predetermined number of packets have been transmitted. However, STS exit conditions are discussed in more detail below. As previous noted, uplink transmission modifications may apply only to uplink transmissions associated with the respective service flow, all uplink transmissions of the terminal, or a subset of uplink transmissions that includes at least the uplink transmissions of the respective service flow. The application of modified transmissions may also be dependent on the granularity with which uplink transmission parameters may be modified. For example, if the minimum set of resources that modifications may be applied to also carry uplink data unrelated to the service flow, uplink transmission modifications may necessarily be applied not only to the transmission of uplink data associated with the service flow.

Although the terminal may make modifications to increase and decrease the resilience of uplink transmissions, in some examples the terminal may be limited to only increasing or decreasing uplink transmission resilience. For example, the terminal may enter into a STS only in response to one or more of the trigger conditions associated with increasing the resilience of uplink transmissions, and therefore only apply resilience enhancing modifications when in a STS. Alternatively, the terminal may enter into a STS only in response to one or more trigger conditions associated implementing resilience reducing/efficiency enhancing modification, and therefore only apply resilience reducing modifications when in a STS. The transmission modifications performed when a terminal is in a STS may also be dependent on the service flow. For example, when a terminal is in a STS state for a particular service flow, the terminal may be configured to implement a particular set of transmission modifications that are predefined for the service flow.

If the uplink transmission modifications implemented by the terminal affect the signal received by the base station, it may be necessary for the base station to have knowledge of the specific modifications and when they are to be implemented, and in possible alter its behaviour. For example, if the terminal enters a STS in response to a trigger condition that the base station will not have knowledge of, the terminal will be required to indicate entry into the STS to the base station. Likewise, if the modifications that are to be implemented are not known by the terminal, this may also be required to be signalling to the base station. Similarly, if the uplink transmission modifications relate to resource allocations, the base station may be required to adapt its uplink resource allocation procedure.

A terminal may also utilise entry into a STS to control entry into a reduced power mode, in which further restrictions on transmissions may occur. The specific nature of the restrictions may also be dependent on the type of terminal and its functionality. For example, for non-safety critical applications, transmissions may be skipped instead of their resilience merely being reduced.

### Exiting Survival Time State

Once a terminal has entered into a STS, different conditions may result in the terminal exiting the STS and thus the terminal returning to performing unmodified uplink transmissions. A range of example exit conditions are detailed below.

A first exit condition for a terminal to exit a STS is the expiry of the respective survival timer. For example, upon entry into a STS a timer may be initialised with the relevant survival time, and the terminal remains in the STS until the timer expires. The base station may also have knowledge of the survival timer and when it was started, either via having knowledge of the relevant trigger condition for entering the STS or by virtue of the terminal signalling entry into the STS to the base station or by virtue of terminal starting the timer in response to a command/feedback from the base station. Consequently, the base station may be aware of when modifications to uplink transmission may start and cease. In some situations, a running survival timer may be reset when a further trigger for entry into a STS state occurs whilst the terminal is in the STS state. The survival timer at the terminal may be synchronised with survival times/timers at the network level or may be independent.

A second condition exit is that a terminal exits a STS based on the receipt of an RLC ACK or a NACK or the status (i.e. toggling) of an NDI in DCI from which an inference of a HARQ ACK/NACK can be obtained. For example, if the terminal entered a STS in response to an indication or inference of a failed transmission e.g. a NACK, absence of an ACK etc, the terminal may exit the STS and return to performing uplink transmissions in an unmodified manner in response to receiving an indication of a successful transmission, such as the receipt of an ACK, the timely receipt of an ACK, or the toggling of a NDI bit compared to a previous transmission for the same HARQ process.

Alternatively, if the terminal entered the STS in response to an indication or inference of a successful transmission e.g. an RLC ACK or toggling of a NDI bit compared to a previous transmission for the same HARQ process, and subsequently performed uplink transmissions with reduced resilience, the terminal may exit the STS and return to performing uplink transmissions in an unmodified manner in response to receiving an indication of an unsuccessful transmission, such as the receipt of an NACK, the absence of an ACK, the late receipt of an ACK, or NDI bit not being toggled compared to a previous transmission for the same HARQ process. As well initiating the exiting of a terminal from a STS, the receipt of an ACK, NACK etc. may also cause the terminal to re-enter a STS and modify uplink transmission based on the most recent feedback e.g. exit a STS in which uplink transmissions are modified to have a lower resilience and enter a STS in which the resilience of uplink transmissions is increased in response to a NACK.

A third exit condition for exiting a STS is that the conditions that triggered entry into the STS are longer present. For example, if the trigger for entry was a deterioration of a channel, if the channel improves, the terminal may exit the STS.

A fourth exit condition is the receipt of an explicit command for exit from the STS received from the base station via a MAC CE or through higher layer signalling. Alternatively, the application itself may request that the terminal exit the STS, for example, in response to a safety critical event. The terminal itself may also trigger exit from the STS in response to a particular event.

As an alternative to explicitly exiting a STS, a terminal may alter the modifications applied to uplink transmissions when an ACK or a NACK or other feedback is received or when other conditions change whilst the terminal is in the STS. For example, the receipt of a NACK may cause the terminal to switch from resilience decreasing modifications to resilience enhancing modifications or cause a terminal to make further resilience enhancing modifications. Opposite actions may be taken upon timely receipt of an ACK.

A further condition is for a terminal to exit a STS in response to a predetermined number of packets being transmitted whilst in the STS, in response to transmission of all data in a transmission buffer, the expectation that no more will data will be required to be transmitted within a specified period of time for the service flow, or in response to radio link failure.

Although the various conditions for exiting a STS have been described separately, they may also be applied in combination. For example, upon entry into a STS state, a survival timer may be initiated with the configured survival time and the terminal will exit the STS upon its expiry. However, if a different condition for exiting the STS occurs before the expiry of the timer (e.g. receipt of a NACK), the terminal may exit the STS in response to this different condition.

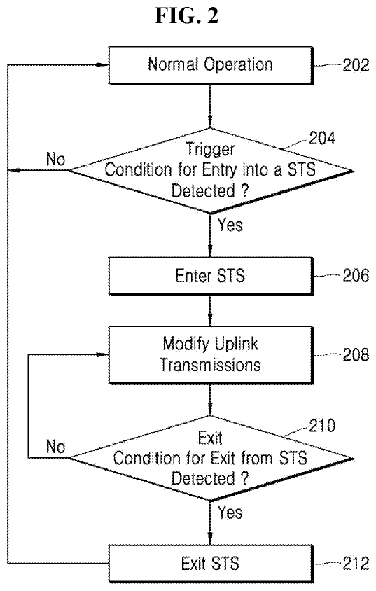

Examples illustrating the application of a survival time to uplink RAN transmissions are described below in conjunction with FIGS. 2 to 6. Although FIGS. 2 to 6 provide specific combinations of STS trigger conditions, uplink transmission modifications, and STS exit conditions, the present disclosure is not limited to these specific combinations, and implementations can be based any combination of STS trigger conditions, uplink transmission modifications, and STS exit conditions described above. Furthermore, as previously noted, although the examples of FIGS. 2 to 6 are based on uplink transmissions for a specific service flow, and a STS for the specific service flow, they are not only limited to this. For example, the STS may apply to the terminal as a whole and all uplink transmissions, or the terminal may be in various different STSs for respective service flows.

FIG. 2 provides a flow diagram illustrating an overview of the operations performed by a terminal when applying the concept of a survival time to the uplink of a RAN.

At step 202, the terminal performs operations as normal for the service flow such the terminal transmits uplink data for the service flow in an unmodified manner based on an unmodified set of uplink transmission parameters. The set of unmodified uplink transmission parameters may also be referred to as a first set of uplink transmission parameters.

At step 204 the terminal determines whether a trigger condition for entry into a STS for the service flow has been detected during normal operation. The trigger conditions that the terminal is configured to detect may be one or more of those previously described. The terminal may be configured to periodically determine whether a trigger condition has been detected or perform such a determination upon the receipt of new data from the base station (e.g. feedback) or data obtained from processing at the terminal. Consequently, although the steps of normal operation 202 and detecting a trigger condition for entry into a STS 204 have been illustrated as separate steps, they may be combined or repeated.

If a trigger condition for entry into a STS is not detected by the terminal, the method returns to step 202 and performs operations as normal for service flow such that uplink transmissions for the service flow are performed in an unmodified manner.

If a trigger condition for entry into a STS is detected by the terminal, the terminal enters the STS as at step 206. Although not shown in FIG. 2, one or more further steps may be performed by the terminal upon entry into the STS. For example, the terminal may initialise a timer with a survival time associated with the service flow, the terminal may indicate to the base station that it has entered a STS, or the terminal may indicate uplink transmission modifications that it will make to future transmissions for the service flow to the base station, where the implementation of these further steps is dependent upon the specific trigger condition and transmission modifications, as previously described.

At step 208, when uplink data of the service flow for transmission to the base station is acquired by the terminal (i.e. data that has been generated by the application), the terminal transmits the uplink data to the base station in a modified manner using a modified set of uplink transmission parameters, where the modifications to the transmission parameters may include one or more of the modifications previously described intended to increase or decrease the resilience of uplink transmissions. The set of modified uplink transmission parameters may also be referred to as a second set of uplink transmission parameters. A number of different approaches may be taken to implement step 208, for example, once in the STS the terminal may continue to modify the uplink transmissions until an exit condition is detected. Alternatively, each time data for uplink transmission is acquired, it may be checked whether the terminal is in the STS and then modify the uplink transmissions accordingly.

At step 210, the terminal determines whether an exit condition for exiting from the STS has been detected, where the exit condition may include or more of the conditions previously described. For example, a condition may be expiry of a survival timer associated with the STS or a signal from the base station indicating that the terminal should exit the STS.

If an exit condition for exiting the STS is not detected at step 210, the terminal continues to perform uplink transmissions for the service flow in a modified manner using the second set of uplink transmission parameters or an updated second set of uplink transmission parameters by returning to step 208.

If an exit condition for exiting the STS is detected at step 210, the terminal exits the STS at step 212 and returns to performing operations as normal for service flow, such that uplink transmissions for the service flow are performed in an unmodified manner using an unmodified set of uplink transmissions parameters i.e. the first set of uplink transmission parameters. However, it should be noted that the unmodified uplink transmission parameters utilised when the terminal returns to performing unmodified uplink transmissions may not be the same as those used prior to entry into the STS but may be an updated set of uplink transmission parameters or merely a set of uplink transmission parameter in which the specific resilience enhancing or reducing modifications are no longer present. In other words, the uplink transmission parameters may be unmodified with respect to the standard uplink transmission parameters implemented when the terminal exits the STS rather than unmodified with respect to those used prior to entering the STS.

Although not show in FIG. 2, the trigger conditions for entering a STS may be preconfigured, configured by higher layers, received from the base station or core network, or set by the terminal. Likewise, the specified transmission modifications and the exit condition may be preconfigured, configured by higher layers, received from the base station, or set by the terminal. In the event that the terminal determines such conditions, the terminal may indicate them to the base station or inform the base station when the terminal enters a STS.

FIG. 2 and the following figures are based on the concept of a STS, and uplink transmission modification(s) being performed when in the STS. However, equivalent actions may also be performed without the use of an explicit STS. For example, a survival timer may be started in response to one or more of the previously described triggers and then the state of the timer checked each time data for uplink transmissions is acquired by the terminal. If the timer is running, then modifications to the transmission of the data may be applied, and if time is not running, the transmission of the uplink data may continue as normal in an unmodified form.

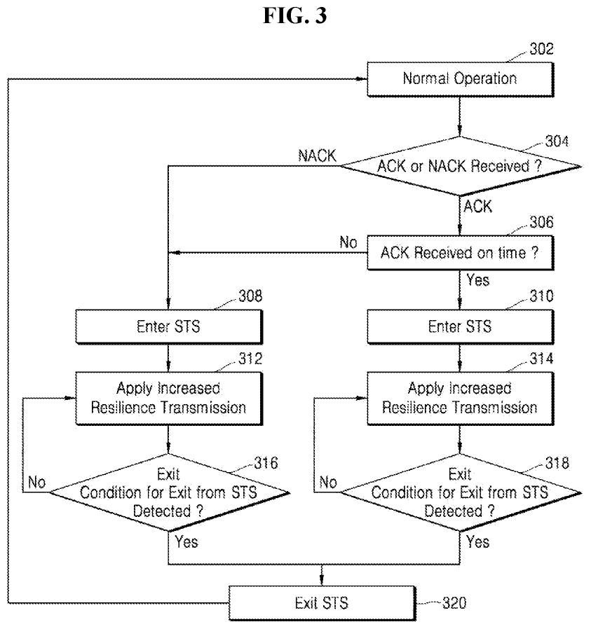

FIG. 3 provides a flow diagram illustrating operations performed by a terminal in an example approach to applying a survival time to the uplink of a RAN. A number of the steps of FIG. 3 correspond to those of FIG. 2 but provide specific examples of the operations performed in the corresponding steps of FIG. 2.

FIG. 3 provides an example implementation in which RLC ACKs and NACKs are utilised as the trigger condition for the terminal to enter a STS when the RLC is operating in acknowledgment mode. However, the steps of FIG. 3 may also be adapted to be based on the other feedback mechanisms discussed above that provide an indication of the success or failure of previous transmissions, such as the NDI bit in DCI or newly defined signalling for example.

At step 302, the terminal performs operations as normal for the service flow such that uplink transmissions for the service flow are performed in an unmodified manner using an unmodified set of uplink transmission parameters (i.e. using a first set of uplink transmission parameters). Step 302 corresponds to step 202 of FIG. 2.

At step 304, since feedback on previous or ongoing transmissions is set as the trigger condition, the terminal determines whether an ACK or NACK associated with the service flow has been received.

If no ACK or NACK is received the terminal returns to step 302 to continue with normal operation with respect to the service flow i.e. it does not enter into a STS, on the basis that no uplink data has been transmitted and so no ACKs/NACKs expected, the absence of feedback does not provide sufficient information to determine whether the terminal should enter a STS and what actions to perform once in the STS, or feedback is not expected in the current configuration (e.g. RLC Unacknowledged Mode). However, in other examples, the absence of an ACK or NACK may be interpreted as a failure of an uplink transmission and therefore the terminal would enter into the STS at step 308

In response to the receipt of a NACK, at step 308 the terminal enters a STS for the service flow. The terminal may also initiate a survival timer at step 308 if exit from the STS is based on expiry of a survival time.

In response to the receipt of an ACK, at step 306 the terminal determines whether the ACK has been received on time or is considered to be late. If the ACK has been received late, the terminal enters the STS at step 308. If the ACK has been received on time, the terminal enters a STS at step 310. As set out above, an ACK may be determined to be late if is received outside of an expected time window following an uplink transmission, where a timer may be used at the terminal to enable such a determination. However, in some examples there may be no definition of a late ACK and therefore regardless of the time the ACK is received the terminal enters a STS at step 310; in other words, step 306 may be not be present in some examples. As for step 308, the terminal may also initiate a survival timer at step 310 if exit from the STS is based on expiry of a survival time.

The terminal has entered the STS at step 308 as a result of feedback indicating the failure of an uplink transmission (e.g. a NACK). Consequently, at step 312, in response to entering the STS, the terminal modifies its uplink transmissions parameters associated with the service flow to increase the resilience of uplink transmission and thus reduce the likelihood of the further uplink transmission failures, which in turn may reduce the likelihood of the communication service for the service flow being deemed to be unavailable. The modifications the terminal may apply may be any of those previously described, and may include, among others, packet duplication, and changes to code rates and modulation orders.

At steps 312 and 316, the terminal remains in the STS and continues to apply resilience enhancing modifications until an exit condition for exiting the STS is detected. The exit condition may be any of those previously set out, for example, the expiry of a survival time or timer started upon entry into the STS at step 308, the transmission of a predetermined number of packets whilst in the STS or the receipt of an ACK or sequence of ACKs that indicates that increased resilience transmissions are no longer required.

When the terminal has entered the STS at step 310 as a result of feedback indicating the success of an uplink transmission (i.e. an ACK), the terminal modifies its uplink transmissions associated with the service flow/application to decrease their resilience, where the particular modifications to decrease resilience may be any of those previously described.

In a similar manner to steps 312 and 316, the terminal continues to apply resilience decreasing modifications until an exit condition for exiting the STS has been detected. The exit condition may be based on any of the previously detailed criteria, for example, the expiry of a survival time or timer started upon entry into the STS at step 310, the transmission of a predetermined number of packets whilst in the STS or the receipt of a NACK that indicates that increased resilience transmissions or at least normal transmissions are required.

Upon exit of the STS at step 320, the terminal returns to performing normal uplink transmission with respect to the service flow at step 302.

Although FIG. 3 illustrates different process flows depending on whether a NACK, an ACK, or neither an ACK or a NACK is received, in some examples a terminal may only enter a STS in response to the receipt of a NACK or the absence of or late receipt of an expected ACK, such that the process flow defined by steps 308, 312, 316, and 320 apply to NACKs and absent/late ACKs but the terminal continues with normal operation otherwise. In order words, the terminal only implements modifications that enhance the resilience of uplink transmissions such that steps 310, 314, and 318 are not included. Alternatively, a terminal may only enter a STS is response to an ACK or an ACK received in a timely manner, such that the process flow defined by steps 310, 314, 318, and 320 apply to ACKs or timely received ACKs, but the terminal continues with normal operation otherwise. In other words, the STS may be associated only with either resilience enhancing or resilience decreasing transmission modifications, such that the STS is entered in response to only one of an ACK or a NACK, and unmodified behaviour continued otherwise.

Examples of the types of uplink transmission modifications implemented based on the type of feedback received are given in the table 1 below, where the terminal is presumed to have entered a STS based on the feedback when transmission modifications are applied. It should be noted that the present disclosure is not limited to these implementations, for example, transmission modifications may be implemented (i.e. a STS entered) in response to any type of feedback, including of an ACK, NACK, late ACK, or the absence of an ACK/NACK, where the type of modification applied (i.e. resilience enhancing or reducing) would be dependent on whether the feedback is considered to represent the success for failure of a transmission.

TABLE 1

| Feedback | | |
|---|---|---|
| Example | ACK | NACK |
| 1 | Decreased | Unmodified |
| | Resilience | |
| 2 | Unmodified | Increased |
| | | Resilience |
| 3 | Decreased | Increased |
| | Resilience | Resilience |

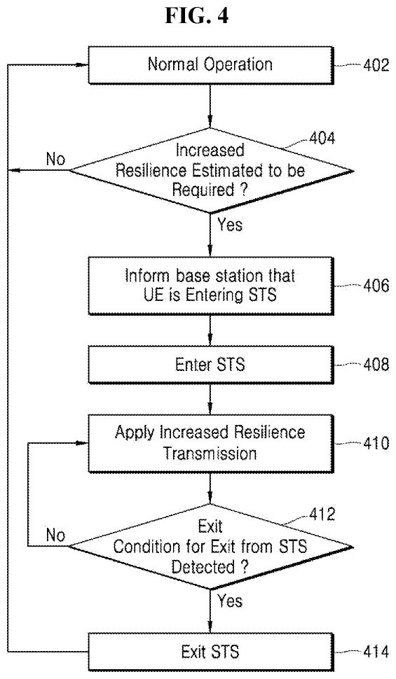

FIG. 4 provides a flow diagram illustrating operations performed by a terminal in another example approach to applying a survival time to the uplink of a RAN. In contrast to FIG. 3, the determination of whether the terminal should enter a STS is based on an estimation procedure based at the terminal as opposed to being based on feedback (e.g. ACKs/NACKS) received from the base station.

At step 402, the terminal performs operations as normal for the service flow such that uplink transmissions for the service flow are performed in an unmodified manner (i.e. using a first set of uplink transmission parameters). Step 402 corresponds to step 202 of FIG. 2.

At step 404, the terminal estimates whether increased resilience uplink transmissions are required. This estimation may be performed as previously described, for example, based on received signal strength indicators or other information that is available at the terminal that may indicate the likelihood of failure of future transmissions.

If the terminal determines that increased resilience transmissions are not required, the terminal continues to makes uplink transmissions for the service flow as normal by returning to step 402. As for FIGS. 2 and 3, during normal operation the terminal may periodically repeat step 404 so that the terminal can enter the STS and perform increase resilience uplink transmission as required.

If the terminal has estimated that enhanced resilience transmissions are required, due to the estimation being performed by the terminal, the terminal informs the base station at 406 that it intends to enter a STS for the service flow. In examples where the resilience enhancing modifications are not preconfigured or may be selected by the terminal, the terminal may also indicate the modifications that are to be applied to the uplink transmission parameters so that the base station can receive the uplink transmissions correctly.

Following informing the base station that the terminal is entering the STS or at the same time as indicating this to the base station, the terminal enters the STS at step 408.

At step 410, whilst in the STS, the terminal modifies its uplink transmissions for the respective service flow/application in order to enhance their resilience, using any of the previous detailed approaches. In other words, the terminal performs uplink transmission based on a modified set of uplink transmission parameters.

The terminal remains in the STS and continues to apply resilience enhancing transmission modifications until it is determined that an exit condition for exiting the STS is detected at step 412. The exit condition may be based on any of the criteria previously described. If the exit condition if not known or able to be detected by the base station, the terminal may also inform the base station that it is exiting the STS and returning to unmodified uplink transmissions.

Upon exit from the STS at step 414, the terminal returns to performing normal uplink transmission with respect to the service flow by returning to step 402.

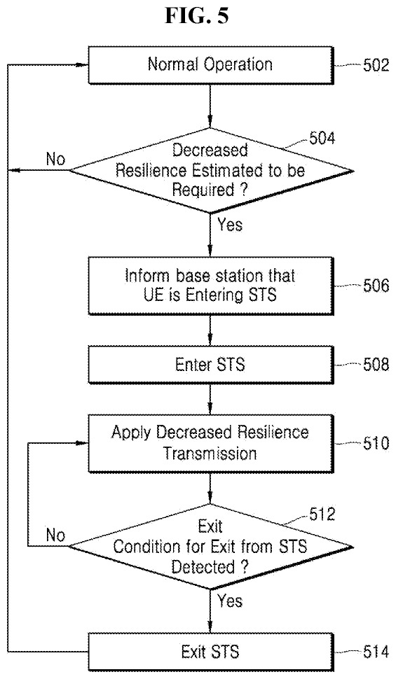

FIG. 5 provides an implementation analogous to FIG. 4 but in which the terminal estimates whether decreased resilience uplink transmissions are required or may be tolerated and thus applies modifications to reduce the resilience of uplink transmissions when in the STS.

In more detail, steps 502, 506, 508, 512, 514 correspond to steps 402, 406, 408, 412, 414 of FIG. 4, respectively. However, steps 504 and 510 differ. In particular, at step 504 the terminal estimates whether reduced resilience transmissions are required. Although the term required is used, this includes determining whether the resilience of uplink transmissions may be decreased without substantially increasing the risk of a communication service for the service flow being deemed unavailable. For example, based on conditions such as received signal strength the terminal may estimate that uplink transmissions may be made with reduced resilience. Alternatively, the terminal may estimate that efficiency increases are required and therefore a reduction in resilience is required to achieve such efficiency advantages.

At step 510, the terminal applies modifications to its uplink transmissions in accordance with any preconfigured modifications or those that have been indicated to the base station at step 506.

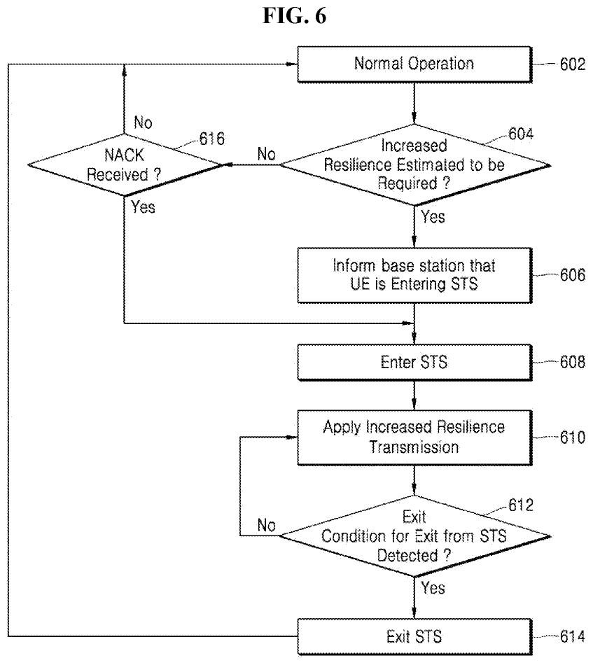

FIG. 6 provides a modified version of the method of FIG. 4 but where an additional criterium for entry in to the STS is provided, such as those set out with respect to FIG. 3. In particular, in FIG. 6 entry into the STS may also be triggered by the receipt of an NACK or equivalent feedback. More specifically, steps 602-614 correspond to steps 402-414 of FIG. 4; however, prior to returning to step 602, a further determination of whether a NACK has been received is provided by step 616, so that transmission failures that may not result in the terminal estimating that the STS should be entered into still result in the terminal entering the STS. Given that the NACK is transmitted by the base station, step 606 may not be performed; however, if the base station is not configured to recognise the transmission of a NACK as a trigger for entering a STS, the terminal may perform step 606 after step 616 before processing to step 608.

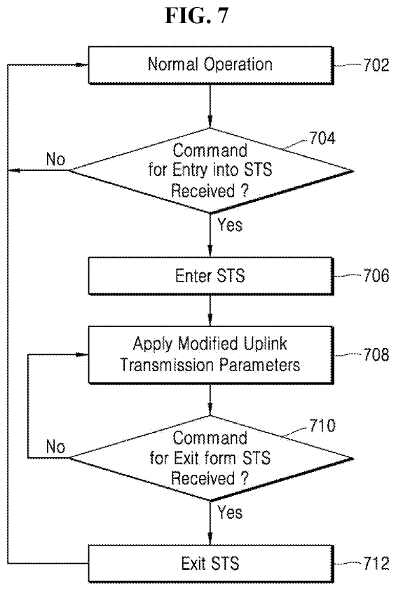

FIG. 7 provides a modified version of the method of FIG. 4 but where the trigger condition for entry into the STS detected at 704 is the receipt of an explicit command from either the network-side or the terminal-side, and the modifications implemented at 708 are dependent on the command. Consequently steps 702, 706, 710, and 712 correspond to steps 402, 408, 412, and 414 of FIG. 4. With respect to network-side commands, these may be in the form of a command in a MAC CE or a command received via high layer signalling. With respect to terminal side commands, these may be received from the application itself, for example when critical information is to be transmitted. The command may also include an indication of whether resilience enhancements or resilience reductions are to be applied to uplink transmissions at step 708 and/or the specific modifications to the uplink transmission parameters.

Although not shown in FIG. 7, if the command is a terminal-side command, the terminal may inform the base station that it is entering/exiting the STS and/or inform the base station of the transmission modifications that are to be implemented if the modifications are not preconfigured.

Although FIGS. 3 to 7 have been described with reference to particular types of transmission modifications, STS trigger conditions, and STS exit conditions, any combination of the transmission modifications, STS triggers, and STS exit conditions may be implemented. Furthermore, the steps of FIGS. 2-7 may be combined or split into smaller steps, or some steps may be omitted if not necessary for certain implementations.

Thus far the actions in relation to uplink transmissions have been predominarly considered with respect to the terminal; however, there is also scope for uplink related actions to be taken by the base station and neighbouring base stations. In relation to this, in some implementations the base station may include a survival timer corresponding to each of those at the terminal so that the base station may adjust its behaviours in synchronised manner with the terminal and/or be aware of whether a terminal is currently in a STS without receiving an explicit indication from the terminal.

Firstly, a base station may adjust its reception of uplink data based on the modifications that the terminal has implemented. For example, if packet duplication, or changes to coding or modulation have been implemented, corresponding behavioural changes at the base station will be required.

Secondly, the base station or neighbouring base station may adjust its resource allocation and transmission parameters of other terminals based on whether the terminal is in a STS in order to accommodate the modified uplink transmission parameters.

In another example, if the base station is aware of a survival time associated with a service flow and/or that a terminal is an a STS, it may restrict or suspend uplink resource allocations associated with the service flow and/or adjust the transmission of acknowledgments related to expected uplink transmissions from the terminal. Subsequently, once the survival time has expired, uplink resources grants, and other uplink-related processes may return to their unmodified form for the next expected data transmissions for the service flow.

A base station may also determine the uplink transmission modifications that a terminal should implement when in a STS or indicate preconfigured modifications to the terminal either in advance of the terminal entering a STS or in response to the terminal entering a STS.

In addition to modifications to the transmissions of user plane data via DRBs, modifications may also include suspending non-user plane data transmissions, such as those associated with a signalling radio bearer (SRB). Restrictions may also be placed on changes that may be made to a service flow(s) with which a survival time is associated, for example, the priority of logical channels or logical channel groups may not be changed, the grants for a particular service flow may be not changed, or scheduling requests (SRs) may not be made or they may be limited to a subset of applicable SR configurations whilst an associated survival time(r) is running, or PDCP duplication via secondary RLC entity may not be allowed, or use of specific types of grants (such as semi-persistent scheduling or configured grants) may not be allowed.

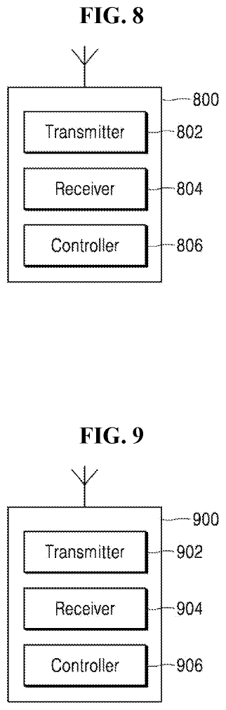

FIG. 8 provides a schematic diagram of the structure of a base station 800 which is arranged to operate in accordance with any of the examples described above. The base station may alternatively be referred to as gNB, eNodeB, RLC entity or other equivalent term. The base station 800 may be serving base station or a neighbouring base station and includes a transmitter 802 arranged to transmit signals to a terminal; a receiver 804 arranged to receive signals from a terminal; and a controller 806 arranged to control the transmitter and receiver and to perform processing such as in accordance with the above described methods, and also to communicate with the core network and neighbouring base stations.

FIG. 9 provides a schematic diagram of the structure of a terminal 900 which is arranged to operate in accordance with any of the examples of the present disclosure described above. The terminal may alternatively be referred to as UE, mobile terminal, device, mobile device, communications device or other equivalent term, and may represent, among other things, a smartphone, an MTC device, an IoT devices, and an IIoT device for example. The terminal 900 includes a transmitter 902 arranged to transmit signals to one or more base stations of a mobile communications network; a receiver 904 arranged to receive signals from one or more base stations of a mobile communications network; and a controller 906 arranged to control the transmitter and receiver and to perform processing in accordance with the above described methods. As well as transmitting signals to and receiving signals from base stations, the terminal may also communicate with relay nodes of a mobile communications network, another terminal of the mobile communications network, or a terminal or access point outside the mobile communications network

Although in FIGS. 8 and 9 the transmitter, receiver, and controller have been illustrated as separate elements, any single element or plurality of elements which provide equivalent functionality may be used to implement the examples of the present disclosure described above. For example, the transmitter and receiver of the base station 800 and terminal 900 may be combined in the form of a transceiver.

In accordance with the present disclosure, a survival time associated with an application may be used to modify the transmission and/or reception of data associated with a service flow in a RAN. For example, if a survival time associated with a particular service flow has not expired (i.e. a survival timer associated with the service flow is running and has not been stopped), transmissions from a first device to a second device or vice versa of data associated with the service flow may be wholly or partially restricted or suspended, thus providing enhancements to uplink and/or downlink scheduling and resource utilisation of both the RAN and the devices without substantially affecting the availability of the communication service from the application's perspective.

The application of a survival time to the RAN is primarily considered with respect to uplink transmissions from a terminal device to a base station, and downlink transmissions from a base station to a terminal device. However, the disclosed techniques are not limited thereto, and may be applied to communications of either direction between any suitable devices.

Different survival times may be associated with different service flows depending on the application corresponding to the service flow or the devices associated with the service flow, where individual survival timers for each service flow may be set with a respective time, and modifications applied when a relevant timer is running (i.e. has not expired or been stopped). Throughout this disclosure, the term service flow covers various different types of data flows between devices, such as a terminal and a base station. For example, a service flow may refer to Quality of Service (QoS) flow, a dedicated radio bearer (DRB), an individual logical channel, a logical channel or channels carrying data of a particular priority or having a priority below a particular threshold, a logical channel group, data of a certain type or having a certain priority, data associated with a specific application, data with a same final destination, or any other specified data bearer. However, the term service flow it is not only limited to these examples and may refer to any classification of data flows between devices and/or core network to which a survival time may be associated. Although it is envisaged that separate survival times will be associated with each service flow, survival times may be allocated to service flows that fulfil certain conditions, such a QoS requirement or priority requirement such that multiple service flows fulfilling a certain conditions may have a single survival time associated with them. Furthermore, although data transmitted via, on or in association with a service is flow is referred to through this disclosure, the described approaches are equally applicable to data packets or messages, such that the data transmissions associated with service flows may also be referred to as data packets or messages.

A wide-range of different types of RAN-based modifications may be implemented whilst a survival time is running for a particular service flow, where the specific modifications available may be dependent on the characteristics of the service flow and the corresponding application, the device under consideration, and the operation of the RAN. For example, data transmission and reception activities associated with a service flow may be completely suspended or partially suspended, and/or losses of data at a receiving device may be tolerated such that requests for repeated transmission are not made.

With respect to the partial suspension or restriction of uplink transmissions, this may include the terminal suspending duplicated transmissions used to enhance the reliability of transmissions, where these transmissions may be to either primary or secondary (e.g. neighbouring) base stations or other RLC entities (e.g. relay nodes, terminals) etc.; restricting repeated transmissions when a first transmission is not successfully received; restricting transmission to a subset of the available antennas; restricting multi-antenna modes that can be used; restricting the use of beamforming; restricting use of relaying; restricting use of multipath transmission; restricting the modulation and coding that may be applied to transmissions; restricting cooperation between cells; restricting transmission powers; suspending transmissions that are likely to lead to increased interference to other users of the RAN; suspending transmissions that utilise particular types of resource grants e.g. dedicated, persistent, semi-persistent or aperiodic resource grants; suspending transmissions that may lead to clashes between granted resources; and selectively restricting transmissions based on channel conditions or other conditions at the terminal. However, the partial suspension of transmission is not limited to these examples but may relate to any RAN transmission of any type or having any suitable characteristic.

With respect to complete suspension of transmissions, data intended for transmission may be discarded or its transmission delayed.

Alternatively, in some examples, whilst a survival timer is running, the generation of data associated with the relevant service flow or other functionality of the terminal may be partially or fully restricted.

Although changes to the transmission behaviour of the terminal have been cast as restrictions, they may also be expressed as permissions. For example, certain behaviour may only be permitted when a survival timer is not running. Consequently, the types of restrictions set out above may be implemented in a permissive manner based on the status of a survival timer.

The type of restriction may be preconfigured, and an indication of the configurations stored at the terminal, or an indication of the specific type of restrictions to apply to a service flow may be indicated to the terminal by the base station depending on the intended level of autonomy of the terminal.

Along with uplink behavioural changes at a terminal, the base station of the RAN may also modify (e.g. restrict) its uplink-related transmissions and scheduling based on a survival time. For example, if the base station is aware of a survival time associated with a service flow, it may restrict or suspend uplink resource allocations associated with the service flow and/or suspend the transmission of negative acknowledgments related to expected uplink transmissions from the terminal. Subsequently, once the survival time has expired, uplink resources grants and other uplink-related processes may return to their unmodified (i.e. unrestricted) form for the next expected data transmissions for the service flow.

A survival time may also be used to determine when a terminal may enter a reduced-power mode in which restrictions on transmissions may occur. The specific nature of the restrictions may also be dependent on the type of terminal and its functionality. For example, for applications/terminals which may provide safety critical functionality, there may be exceptions to restrictions that allow for data carrying safety critical data to be transmitted.

In addition to the suspension of transmissions of user plane data via DRBs, restrictions may also include suspending non-user plane data transmissions, such as those associated with a signalling radio bearer (SRB). Restrictions may also be placed on changes that may be made to a service flow(s) with which a survival time is associated, for example, the priority of logical channels or logical channel groups may not be changed, the grants for a particular service flow may be not changed, or scheduling requests (SRs) may not be made or they may be limited to a subset of applicable SR configurations whilst an associated survival time(r) is running, or PDCP duplication via secondary RLC entity may not be allowed, or use of specific types of grants (such as semi-persistent scheduling or configured grants) may not be allowed.

With respect to modifications related to downlink transmissions, whilst a survival time is running at the terminal, the terminal may modify its reception activities associated with the service flow. For example, the terminal may not attempt to receive data included in resources that have been allocated to it, not provide negative acknowledgments for expected data that has not been received, or not react to the unsuccessful reception of data i.e. tolerate the loss of data, in the downlink. Alternatively or additionally, the terminal may cease all reception activities for the period of the survival time.

Along with downlink behavioural changes at the terminal, changes may also be implemented at the base station. For example, whilst a survival time is running at the base station it may modify its downlink related activities by restricting or suspending downlink transmissions associated with the service flow in any of the manners set out above for the uplink restrictions and/or modifying its resource allocation procedure. Consequently, advantages in terms of downlink scheduling and resource utilisation in the downlink may also be obtained via the application of a survival time to the RAN.

It is envisaged that the survival time for a particular service flow will correspond to that used by the core network for the particular service flow or that set by the application corresponding to the service flow, such that restrictions on RAN transmission and reception activities based on a survival time will not affect the availability of communication service associated with the service flow. However, in some examples, the survival time implemented in a RAN may differ from that used by other entities in the network and the application in order to account for factors such as latency and processing time associate with a RAN.

When applying survival times to a RAN, they may be implemented at one of or both of the terminal and base station, where the location of their implementation may determine their effect on uplink and downlink transmissions.

In a first example, a RAN-based survival time may be implemented at the base station and therefore modifications may be applied to downlink transmissions, including the allocation of uplink resources. The configuration of the survival time in this case may be based on information received from the core network or be preconfigured, where such information may include an identifier of the service flow, a value of the survival time, and an appropriate trigger condition for starting of the survival time. The specific modifications may be any of those described above.

In a second example, a RAN-based survival time may be implemented at the terminal. Configuration of the survival time may be performed by the base station or based on preconfigured information stored at the terminal, where the configuration information may include an identifier of the service flow, a value of the survival time, and an appropriate trigger condition for starting of the survival time, and where an indication of the configuration information may be indicated to the terminal by the base station. In some implementations, a survival time may be implemented independently by a terminal based on preconfigured information stored at the terminal. As for the first example, the configuration information may also be based on information received from the core network by the base station. In this example, modifications may be applied to the transmission of data in the uplink and the reception of data in the downlink by the terminal device. The specific modifications may be any of those described above.

In a third example, corresponding survival times for a service flow are implemented at both the base station and terminal, and therefore modifications (e.g. those of the first and second examples) may be applied to both uplink and downlink transmission and reception at both the base station and terminal. In this case the configuration of the survival times may be performed by the base station and the configuration information indicated to the terminal. Once again, the configuration information may originate from another network device or entity, such as the core network or an interface towards the core network and be communicated to the terminal or be preconfigured. The specific modifications may be any of those described above.

An indication of a survival time provided to the terminal by the base station may include an actual value of the survival time or may include a survival time index which can be used to identify a survival time using a prestored table for example. Survival times may also be preconfigured or reconfigured based on one or more of a complexity of the terminal (e.g. its processing, transmission, and reception capabilities), a number of antennas at the terminal, types of transmission modes supported by the terminal, a relay capability of the terminal, a current status of the terminal, and an application associated with the service flow or terminal, either with or without control of the base station.

Once a survival time for a particular service flow has been identified, a timer (e.g. a survival timer) for the service flow will be set to the survival time. The setting of the survival timer may be performed in response to the identification of the survival time or alternatively may be performed when the survival timer is required to be started. Given that a plurality of service flows may exist between a terminal and a base station, a plurality of timers may be implemented at either the terminal and/or base station.

A survival timer may be started in response to a predetermined trigger or triggers, which may include the transmission of a packet associated with the relevant service flow; receiving an acknowledgment (ACK) for a previous or last transmission associated with the relevant service flow; a protocol data unit (PDU) submission associated with the relevant service flow to a lower layer; an arrival of a service data unit (SDU) associated with the relevant service flow from a higher layer; or the receipt of an explicit trigger from the base station, terminal or core network. However, potential trigger mechanisms are not only limited to these and may take any suitable form, for example, survival timers may be started when a battery level at the terminal is equal to or below a predetermined level such that power can be conserved at the terminal. In some examples, certain conditions may be required to be satisfied prior to starting a survival timer, such as ACKs having been received for data previously transmitted.

Once a survival timer is running for a particular service flow, modifications may be implemented in a number of different manners. For example, each request for a data transmission associated with the particular service flow may be assessed against the restriction criteria and then the appropriate data transmitted/not transmitted, or all newly received data for the service flow intended for transmission (e.g. newly arrived packet data convergence protocol (PDCP) SDUs) may be discarded or stored for transmission at a later time. Alternatively, with specific respect to the terminal, it may be instructed by the base station to suspend the provision of data intended to be transmitted to the base station, which may lead to improvements in energy consumption or radiated power at the terminal or interference to other users for example.

The modifications to transmissions from either a terminal or a base station for a service flow on which a survival timer is running may cease either when the survival timer expires, or the survival timer is stopped in response to a predetermined condition occurring. For example, a survival timer for a service flow may be stopped prior to its expiry if a radio link control (RLC) status report including negative acknowledgment (NACK) is received for a previous transmission, a hybrid automatic request (HARQ) NACK for a previous transmission is received, or an explicit request or indication for stopping of a survival timer is received from the base station or terminal. Alternatively or additionally, a survival timer may be stopped in response to a particular condition being satisfied or the occurrence of a particular event at the terminal, such as a safety critical event occurring. By allowing for the receipt of a NACK to trigger the stopping of a survival timer, a terminal or base station can promptly transmit data that has not been successfully received. Alternatively, the use of NACKs to stop a survival timer can be used to ensure that required data transmissions take place even though the a survival timer may be running. For example, if a required data transmission does not take place, a NACK can be transmitted to the terminal or base station, and the terminal or base station can then stop the relevant survival timer and respond to the NACK, by transmitting the relevant data for example.

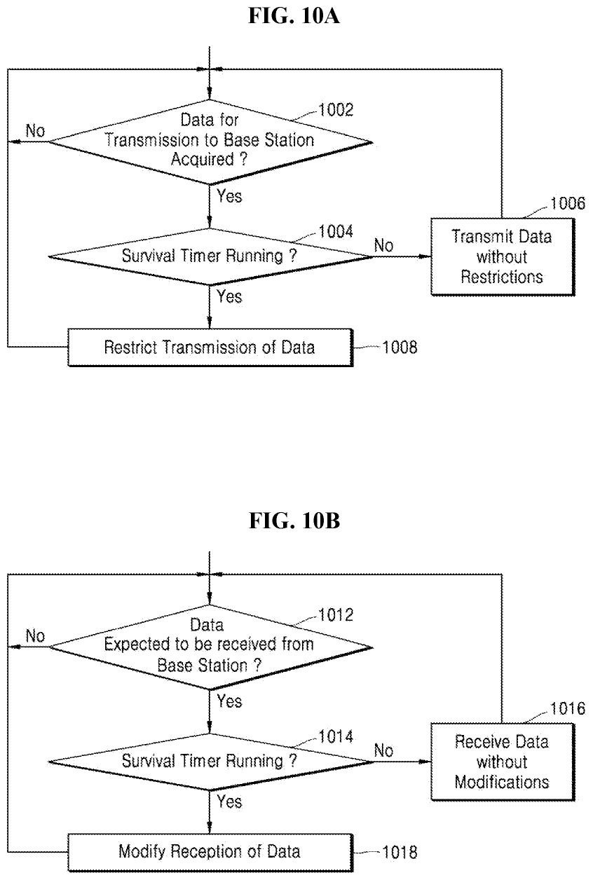

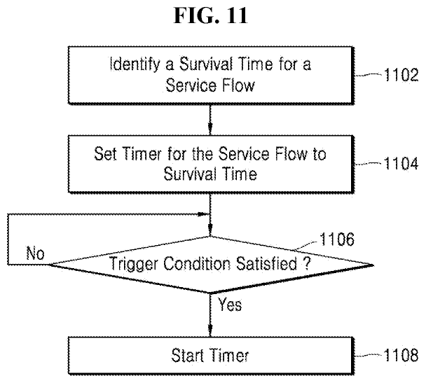

FIG. 10A provides a flow chart illustrating an example implementation of modifications to transmissions from a terminal based on a survival time at a terminal for a particular service flow, where the modifications take the form of transmission restrictions. However, the approach of FIG. 10A is equally applicable to transmissions for a particular service flow from a base station to a terminal or between any two suitable devices, and any form of transmission modification set out above.

At step 1002 it is determined whether data associated with the particular service flow for transmission to the base station is acquired, where the data may be received in the form of a PDCP SDU from a higher layer for example.

At step 1004, it is determined whether a survival timer corresponding to the service flow is running (i.e. one exists and it has not expired or been stopped). If the survival timer is not running, transmission of the received data to the base station continues in an unrestricted manner at step 1006, and once transmission has taken place the method may return to step 1002. If the survival timer is running, transmission of the data is fully or partially restricted at step 1008 in accordance with one or more of the approaches described above, and the method may then return to step 1002.

Although FIG. 10A shows particular processing steps that take place at the terminal in a particular order, the operation of the terminal is not limited to such an order. For example, the determination of whether a survival timer is running may occur prior to determining if data associated with the service is received. Furthermore, one or more additional steps controlling the stopping of a survival timer in response to predetermined condition may also occur in parallel to FIG. 10A to ensure that the survival timer is promptly stopped when required, for example, when a NACK is received.

FIG. 10B illustrates a similar approach to that of FIG. 10A but where modifications are applied to the reception of data associated with a particular service flow at a terminal.

At step 1012 it is determined whether data associated with the particular service flow is expected to be received from a base station.

At step 1014, it is determined whether a survival timer corresponding to the service flow is running (i.e. one exists and it has not expired or been stopped). If the survival timer is not running, reception of the expected data from the base station continues in an unmodified manner at step 1016, and once reception has taken place the method may return to step 1012. If the survival timer is running, reception of the expected data is performed in a modified manner at step 1018 in accordance with one or more of the approaches described above, and the method may then return to step 1012. For example, reception of the relevant resources may be not attempted, restrictions may be placed on requests for unsuccessfully received data, or unsuccessful reception of data tolerated and no further RAN-related action taken in relation to the unsuccessful reception of the data.

FIG. 11 provides a flow chart illustrating the initiation and starting of a survival timer at a terminal, although the approach is equally applicable to any device where a survival timer may be implemented, such as a base station for example.

At step 1102, the terminal identifies a survival time associated with a service flow. As set out above, the survival time may be identified based on a indication provided by the base station, based on information stored at the terminal, based on information received from the core network or an interface to the core network, information from another network entity, or a combination of these.

At step 1104 a survival timer for the service flow is set to the identified survival time.

At step 1106, it is determined whether a trigger condition(s) for the start of the survival timer is satisfied, where the trigger condition(s) may be anyone of those listed above. If the trigger condition(s) is not satisfied, the survival timer is not started and the detection of a trigger condition may be performed at regular intervals to ensure that the survival timer is started when necessary. If a trigger condition is satisfied, the survival timer is started at step 1108 and the transmission and/or reception of data may then take place in accordance with the method of FIGS. 10A and 10B.

The method of FIG. 11 may be performed in parallel to the methods of FIGS. 10A and 10B so that survival timers are appropriately configured and started at the base station and/or terminal. In some examples, steps 1102 and 1104 may be performed in response to initialisation the terminal or at predetermined intervals. In other examples, the method of FIG. 11 may be performed upon initialisation of a terminal and upon expiry of a survival timer. In yet other examples, currently running survival timers may be reset when an appropriate trigger condition is detected, for instance, although step 1104 has been illustrated as a separate step to 1106, a survival timer may in some examples be set and started in response to a trigger condition being satisfied, thus effectively resting the survival timer is response an appropriate trigger condition.

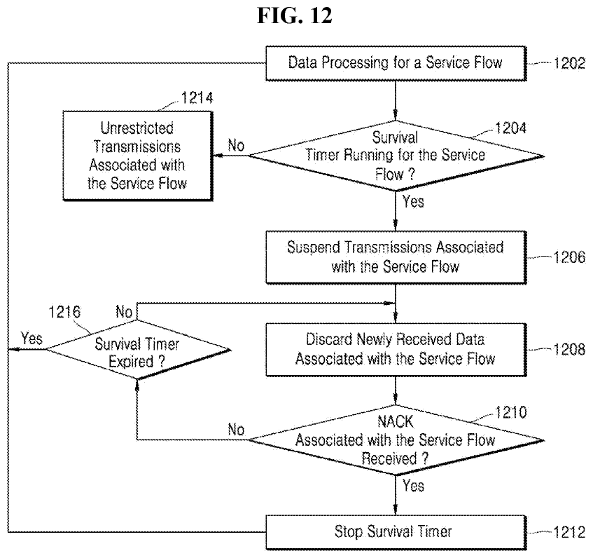

FIG. 12 provides a flow diagram illustrating a more detailed example implementation of a survival timer at a terminal in accordance with the present disclosure where all transmissions associated with a service flow are suspended when a survival timer is running. In a similar manner to FIGS. 10A, the approach of FIG. 12 is equally applicable to the transmission of data associated with a particular service flow from a base station to a terminal.

At step 1202 data processing for data associated with a specified service flow takes place.

At step 1204, it is determined whether a survival timer for the service flow is running. If a survival timer is not running, transmissions associated with the service flow may be performed in a normal unrestricted/unmodified manner at step 1214. If a survival timer is running, transmissions associated with the service flow are suspended at step 1206.

At step 1208, newly received data associated with the service flow and intended for transmission are discarded, or in some examples, stored for later transmission, where such newly received data may be PDCP SDUs.

At step 1210 it is determined whether a NACK associated with the service flow is received from the base station. If a NACK is received, the survival timer is stopped at step 1212, and the processing returns to step 1202. If a NACK has not been received, it is determined at step 1216 whether the survival timer has expired. If the survival time has not expired, the method returns to step 1208. If the survival timer has expired, the method returns to step 1202.

Although FIG. 12 sets of specific order of steps for the implementation of a survival time in a RAN, the present disclosure is not limited to such an order or the specific steps on FIG. 12. For example, transmissions may only be partially suspended in step 1206 or modified in any manner described out above, and newly received data may be stored for later transmission or only particular types of data discarded. Similarly, the stopping of the survival timer may not only be performed in response to the receipt of an NACK but also its response to other events, such as a receipt of an indication from the base station or an event occurring at the terminal that requires transmission to the base station that are currently suspended to be performed.

As for FIGS. 10A and 10B, FIG. 12 does not include the initiation and triggering of the survival timer described with reference to FIG. 11, however, the method of FIG. 11 may be performed in parallel with the method of FIG. 12.

Although FIGS. 10A to 12 have been described with reference to particular types of transmission restrictions, timer start conditions and so on, any combination of the conditions for starting a survival timer, conditions for stopping a survival timer, the type of modifications placed upon transmissions for a service flow, and the type of service flows to which survival times and timers may be applied may be used. Furthermore, although not illustrated in FIG. 12, when restrictions are placed on transmissions, resources made available by such restrictions may be allocated to other communications between the terminal and base station.

According to an aspect of the present disclosure there is provided a method of a first communications device for communicating data associated with a service flow between the first communications device and a second communications device, the method comprising: identifying a survival time for the service flow between the first communications device and the second communications device; setting a timer to the identified survival time; starting the timer in response to a predetermined trigger condition; and whilst the timer is running, modifying at least one of: transmission of data associated with the service flow to the second communications device, and reception of data associated with the service flow from the second communications device

In an example of the present disclosure, the service flow includes one or more of a quality of service flow, a dedicated radio bearer, a logical channel, a logical channel group, data of a specific type, a specific data or signalling bearer, data associated with a specific application, and data with a same final destination.

In another example of the present disclosure, modifying the transmission of data associated with the service flow includes one or more: suspending transmission of all data associated with the service flow; suspending duplicated transmissions associated with the service flow; suspending transmission of data associated with the service flow having a priority below or above a predetermined threshold; suspending transmission of data of a predetermined type associated with the service flow; discarding service data units, SDUs, associated with the service flow received from a higher layer; suspending an allocation of resources for transmission of data associated with the service flow; reducing a transmission power; and suspending transmission of negative acknowledgments, NACKs associated with the service flow.

In another example of the present disclosure, identifying the survival time includes receiving an indication of the survival time from the second communications device, receiving an indication of the survival time via higher layer signalling, identifying the survival time based on one or more survival times stored at the first communications device, or receiving an indication of the survival time from a third device.

In another example of the present disclosure, the survival time is preconfigured, configured, or reconfigured based on one or more of a complexity of the first communications device, a number of antennas at the first communications device, types of transmission modes supported by the first communications device, a relay capability of the first communications device, and an application associated with the service flow or first communications device.

In another example of the present disclosure, the method further includes, upon expiry or stopping of the timer, performing unmodified transmission and reception of data associated with the service flow.

In another example of the present disclosure, the method further includes stopping the timer in response to receiving a negative acknowledgment, NACK, associated with the service flow from the second communications device, transmitting a NACK associated with the service flow to the second communications device, or receiving a timer stop indication from the second communications device.

In another example of the present disclosure, the NACK is a hybrid automatic repeat request, HARQ, NACK or a NACK included in a radio link control, RLC, status report.

In another example of the present disclosure, the predetermined trigger condition includes one or more of: transmitting data associated with the service flow to the second communications device; receiving a positive acknowledgment associated with the service flow from the second communications device; submitting a protocol data unit, PDU, associated with the service flow to a lower layer; receiving a service data unit, SDU, associated with the service flow from a higher layer; receiving a timer start indication from the second communications device.

In another example of the present disclosure, the survival time is a time period that a communications service for the service flow is deemed to be available regardless of whether scheduled data for the service flow due to be communicated between the first and second communications devices during the time period is successfully communicated or not.

In another example of the present disclosure, the method further includes determining the availability of communications for the service flow based on a status of data associated with the service flow scheduled to be received from or transmitted to the second communications device, and, whilst the timer is running, restricting the use of the status of data associated with the service flow scheduled to be received or transmitted in the determination of the availability of communications for the service flow.

In another example of the present disclosure, modifying the reception of data associated with the service flow includes at least one of restricting reception of data associated with the service flow scheduled to be transmitted from the second communications device to the first communications device, and tolerating the unsuccessful reception of data associated with the service flow transmitted from the second communications device to the first communications device.

In another example of the present disclosure, the first communications device and the second communications device are each one of a base station, a mobile device, and a relay device.

In another example of the present disclosure, first and second communications devices are included in a 3GPP compliant 5G New Radio, NR, mobile communications system.

According to an aspect of the present disclosure there is provided a first communications device for communicating data associated with a service flow between the first communications device and a second communications device, the first communications device comprising a controller, and a transceiver, wherein the controller is configured to identify a survival time for the service flow between the first communications device and the second communications device; set a timer to the identified survival time; start the timer in response to a predetermined trigger condition; and whilst the timer is running, modify at least one of transmission of data associated with the service flow by the transceiver to the second communications device, and reception of data associated with the service flow from the second communications device.

According to an aspect of the present disclosure there is provided a computer readable storage medium having stored thereon computer executable instructions which when executed by a computer cause the computer to perform any of the above methods.

Throughout the description and claims of this specification, the words “comprise” and “contain” and variations of them mean “including but not limited to”, and they are not intended to (and do not) exclude other components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers or characteristics described in conjunction with a particular aspect, embodiment or example of the present disclosure are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The disclosure is not restricted to the details of any foregoing embodiments. Examples of the present disclosure extend to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

The various embodiments of the present disclosure may also be implemented via computer executable instructions stored on a computer readable storage medium, such that when executed cause a computer to operate in accordance with any other the aforementioned embodiments.

The above embodiments are to be understood as illustrative examples of the present disclosure. Further embodiments are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be used without departing from the scope of the invention, which is defined in the accompanying claims.

1-15. (canceled)

16. A method of a terminal in a mobile communications system, the method comprising:
receiving, from a base station, configuration information for a radio bearer associated with a survival time;
receiving, from the base station, an indication to trigger to enter into a survival time state for the radio bearer associated with the survival time;
in response to the indication, activating a packet data convergence protocol (PDCP) duplication for the radio bearer associated with the survival time; and
transmitting, to the base station, uplink data based on the radio bearer associated with the survival time.

17. The method of claim 16, wherein the configuration information is based on information received by the base station from a core network.

18. The method of claim 16, wherein the survival time is an actual value of time.

19. The method of claim 16, further comprising transmitting, to the base station, capability information indicating that the terminal supports the survival time.

20. A terminal in a mobile communications system, the terminal comprising:
a transceiver;
a memory; and
a processor configured to:
receive, from a base station, configuration information for a radio bearer associated with a survival time,
receive, from the base station, an indication to trigger to enter into a survival time state for the radio bearer associated with the survival time,
in response to the indication, activate a packet data convergence protocol (PDCP) duplication for the radio bearer associated with the survival time, and
transmit, to the base station, uplink data based on the radio bearer associated with the survival time.

21. The terminal of claim 20, wherein the configuration information is based on information received by the base station from a core network.

22. The terminal of claim 20, wherein the survival time is an actual value of time.

23. The terminal of claim 20, wherein the processor is further configured to transmit, to the base station, capability information indicating that the terminal supports the survival time.

24. A method of a base station in a mobile communications system, the method comprising:
transmitting, to a terminal, configuration information for a radio bearer associated with a survival time;
transmitting, to the terminal, an indication to trigger to enter into a survival time state for the radio bearer associated with the survival time; and
receiving, from the terminal, uplink data according to the radio bearer associated with the survival time,
wherein in response to the indication, a packet data convergence protocol (PDCP) duplication for the radio bearer associated with the survival time is activated.

25. The method of claim 24, wherein the configuration information is based on information received by the base station from a core network.

26. The method of claim 24, wherein the survival time is an actual value of time.

27. The method of claim 24, further comprising receiving, from the terminal, capability information indicating that the terminal supports the survival time.

28. A base station in a mobile communications system, the base station comprising:
a transceiver;
a memory; and
a processor configured to:
transmit, to a terminal, configuration information for a radio bearer associated with a survival time,
transmit, to the terminal, an indication to trigger to enter into a survival time state for the radio bearer associated with the survival time, and
receive, from the terminal, uplink data according to the radio bearer associated with the survival time,
wherein in response to the indication, a packet data convergence protocol (PDCP) duplication for the radio bearer associated with the survival time is activated.

29. The base station of claim 28, wherein the configuration information is based on information received by the base station from a core network.

30. The base station of claim 28, wherein the survival time is an actual value of time.

31. The base station of claim 28, wherein the processor is further configured to receive, from the terminal, capability information indicating that the terminal supports the survival time.
